(19) United States
(12) Patent Application Publication
(10) Pub. No.: US 2003/0164844 A1
(43) Pub. Date: Sep. 4, 2003

(54) System and method for processing multimedia content, stored in a computer-accessible storage medium, based on various user-specified parameters related to the content

(76) Inventors: Dean Todd Kravitz, Cliffside Park, NJ (US); Elisabeth Ann Spiotta, Cliffside Park, NJ (US)

Correspondence Address: Larry Liberchuk, Esq., P.O. Box 266, Cliffside Park, NJ, 07010, US

(21) Appl. No.: 09/998,287

(22) Filed: Nov. 30, 2001

Related U.S. Application Data
(63) Continuation of application No. 09/669,246, filed on Sep. 25, 2000.

(51) Int. Cl. G09G 5/00

(52) U.S. Cl. 345/700; 345/968

(57) ABSTRACT

System and method for processing multimedia content, stored in a computer-accessible storage medium, based on various user-specified parameters related to the content. A user enters one or more search parameters to find music track or other multimedia item suitable for an advertising commercial, corporate video, recreational purposes, home video, etc. The search engine receives the entered parameters and retrieves search results, if any. The obtained search results may be sorted, displayed, retrieved, played, downloaded, sorted, manipulated, sent to various locations, stored and/or recalled, as well as other operations, according to various user selections.

### BACKGROUND OF THE INVENTION

The present invention relates generally to multimedia content. More particularly, the present invention relates to a system and method for searching, sorting, displaying, retrieving, playing, downloading, storing and performing other operations on multimedia content, stored in a database or any other computer-accessible storage medium, based on one or more user specified parameters.

The Standard Directory of Advertisers, commonly referred to as the “Red Book” advertising resource, lists more than 1080 U. S. advertising agencies billing clients over $1 million annually. According to a report by the American Association of Advertising Agencies, 21 of the 100 highest grossing agencies spent $43 million on music for national television commercials in 1997.

The typical process of incorporating music in advertising production is as follows. An advertising agency's broadcast producer meets internally with creative personnel (usually art directors and copywriters) to conceptualize and plan the creation of a new television or radio commercial. Rarely does the creative team specify music at the beginning of the process, except in some cases when the rhythm of the music drives the visuals, such as synching lyrics or on camera movements such as dancing.

In many cases, music is first explored after the filming is done, and the agency begins the visual editing process. Often music tracks from CDs are selected at an edit session as reference and are synchronized to the visuals. If the track is available, then the producer is responsible for contacting the stock music company to complete a license application form, or negotiate license provisions with the popular song publisher or commission an original composition with a higher price point and longer production time

The ability to select the right music from thousands of choices is of critical importance to the industry professional. It is also of critical importance to obtain this music quickly and easily. For advertising professionals, the ability to identify appropriate music efficiently and quickly, using a search engine to navigate music or other multimedia content quickly, is invaluable in meeting tight deadlines. In a consumer environment, a user may want to locate appropriate music for a home video, or locate stock footage to incorporate into a home production, or may simply want to find an item with certain parameters for recreational purposes.

It became evident to the inventors that many of the specific needs of the professionals seeking music were not being met. Search engines were simplistic in their descriptions of the music, offered limited functionality, and neglected to address work processes and business needs confronted on a daily basis by industry professionals.

This invention addresses the prior unmet needs of industry professionals. The inventors drew on their own insights and personal brainstorms based on his and her experiences as a composer, producer, database developer, and further experiences creating original music and finding library music for industry professionals with tight deadlines. The combination of determining what features were needed through personal experience, and the ability to translate these needs into execution, because of the inventors' unique professional background, led to this invention.

A need therefore exists for a system and method that addresses the above concerns, a system and method that solves this long-felt need for a user-friendly, flexible and accurate search engine, among other things.

### SUMMARY OF THE INVENTION

It is an object of the present invention to provide a system and method for processing multimedia content stored in a computer-readable storage medium.

The above and other objects are achieved by a system and method for searching multimedia content stored in a microprocessor-based storage medium. According to the present invention, a user-specified parameter is received relating to a multimedia item, and then the multimedia item is retrieved based on the user-specified parameter. The retrieved item can be manipulated and stored for future recall. For example, one user-specified parameter represents tempo of the retrieved multimedia item such that the tempo is specified by a user-specified number of beats in a predetermined time period.

The user-friendly interface of this invention is connected to a series of databases with many scripts, look-ups, and relationships to share, transfer, and display information. Although the invention could be build using any one of many standard database platforms, the present embodiment of the invention uses Filemaker Pro® as the platform and utilizes programming functions of that software.

### BRIEF DESCRIPTION OF THE DRAWINGS

The present invention is illustrated in the figures of the accompanying drawings which are meant to be exemplary and not limiting, and in which like reference characters are intended to refer to like or corresponding parts:

FIG. 1 shows a block diagram of the system for processing multimedia content, stored in a computer-accessible storage medium, based on various user-specified parameters related to the content;

FIG. 2 is a block diagram of software components or modules residing on a personal computer and/or server in accordance with the present invention;

FIG. 3 is a graphical representation of screen display showing a home page of the web site according to the present invention;

FIG. 4 is a graphical representation of screen display showing a pop-up search page;

FIGS. 5-8 are graphical representations of screen displays showing moods, musical styles, instrumentation, and subjects palettes, respectively;

FIG. 9 is a graphical representation of screen display showing a list of multimedia items for browsing;

FIG. 10 is a graphical representation of screen display showing a list of tracks in a particular volume as selected for browsing;

FIGS. 11 and 12 are graphical representations of screen displays showing basic information and more information views, respectively;

FIG. 13 is a graphical representation of screen display showing a search template that the user completes to name the search;

FIG. 14 is a graphical representation of screen display showing a representative open folder in which tracks have been stored under the folder name “Cinema 2000”;

FIG. 15 is a graphical representation of screen display showing tracks selected for a custom CD/media order;

FIG. 16 is a graphical representation of screen display showing a web page for licensing a track;

FIG. 17 is a graphical representation of screen display showing a usage report;

FIGS. 18A and 18B are graphical representations of screen displays showing a license agreement;

FIG. 19 is a graphical representation of screen display showing a usage rate card;

FIG. 20 is a process flowchart for searching for multimedia items in accordance with the present invention;

FIG. 21 is a process flowchart for displaying, sorting, and previewing the search results in accordance with the present invention; and

FIG. 22 is a block diagram illustrating the database structure in accordance with one representative embodiment of the present invention.

### DETAILED DESCRIPTION OF THE PREFERRED EMBODIMENTS

As a general overview, the present invention includes a system and method for processing multimedia content, stored in a computer-accessible storage medium, based on one or more user-specified parameters related to the content. The processing operations consist of, among other things, searching, sorting, playing, displaying, receiving, retrieving, downloading and storing of data representing or relating to multimedia information, such as music, video, or still photos. In accordance with one representative embodiment of the present invention, the system is comprised of a server communicatively coupled with user terminals over a network and connected to a database for storing, among other things, multimedia content. The inventive method allows users of the system to perform various tasks such that the desired music, video, photo or other multimedia content, as requested by the user, is obtained, manipulated, and/or stored quickly and easily. Additionally, the system provides the necessary forms needed to complete the appropriate business transactions associated with licensing multimedia content.

According to the present invention, the links to the content and information about the content are typically manipulated and stored, and not the content itself. Thus, when this document refers to content being manipulated and stored, it is understood that the links and information about the content is manipulated and stored.

The invention could be used in a consumer or a business-to-business environment. An example of one usage of the invention can be understood in the context of an advertising producer's search for content for his/her productions.

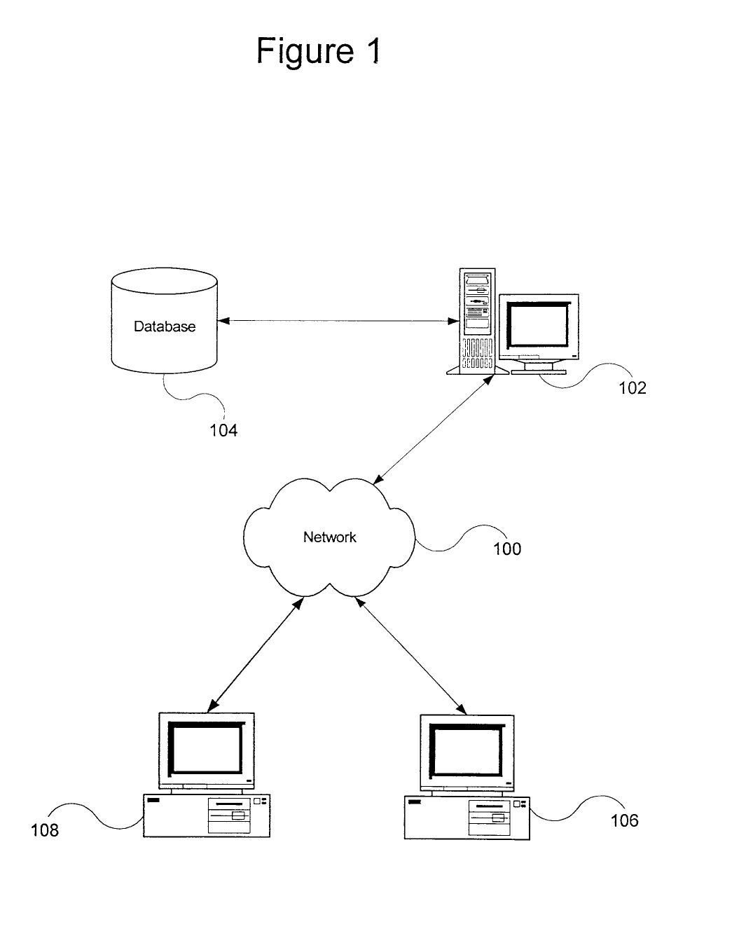

FIG. 1 shows a block diagram of the system for processing multimedia content, stored in a computer-accessible storage medium, based on one or more user-specified parameters. Shown in the figure in block diagram form are personal computers (PC) 106, 108. In one embodiment of the present invention, PC 106 or PC 108 may be a general purpose computer containing a display screen for displaying images, text, etc., a memory storage medium for storing data, an input device for providing user access to the system by entering user input data, a programmable processor for controlling operations of the various PC components, and a network interface device, such as a modem, for connecting the personal computer to a network, thereby providing communication with other personal computers and computer servers. A dial-up modem, DSL modem, cable modem, network card and/or any other interface device, alone or in combination, may be used for accessing other personal computers and computer servers via any wired or wireless communications medium. Additionally, PC 106, 108 may include speakers and/or microphone (not shown) for providing auditory and speech interface between the user and the system.

While only 2 computers—and therefore 2 users—are illustratively shown in FIG. 1, it is understood that a plurality of people may be using the system. It is further understood that each illustrated computer setup may contain other hardware and/or software components or elements that are necessary for the normal operation of a computer, as known to those skilled in the art Since the additional hardware and/or software elements or components are not critical to the understanding of the present invention, a detailed description thereof will be omitted in order not to detract from the present invention

When connected via a network interface device, PC 106 and PC 108 represent 2 respective nodes on network 100. This network may be a global computer implemented network, such as the Internet, or any other type of network, such as intranet, Virtual Private Network (VPN), local area network (LAN), wide area network (WAN), etc. Connected to network 100 via their respective network interface devices is a plurality of users, which may be laypeople or professionals in advertising, television, radio, film and new media, for example. In the present invention, all are representatively referred to as users which may employ a variety of wireless/wired devices to connect to the network: desktop personal computers, portable/laptop computers, wireless/wired personal digital assistants, cellular telephones, specific Web access devices (WebTV), etc. Collectively, any one of these network users operating PC 106 or PC 108 is representatively referred to herein as PC 106 or PC 108, respectively, as shown in FIG. 1.

Also connected to network 100 is server 102 for processing user requests and accessing a database. Database 104, connected to server 102, stores data representing multimedia content, such as music tracks, still photos, video clips, etc., license/purchase agreements, purchasers information, as well as other information in connection with the present invention, as explained in detail below. Also stored in server 102 may be user registration information to gain access to the system. It is understood that the database may be remotely located from the server or, alternatively, may be co-located with the server. Furthermore, the database may be a distributed database, comprised of a cluster of databases. Additionally, the functionality of the entire system may be contained within one computer utilizing either CD-ROM or other local content sources, or accessing content via a server on a network or via the WWW. The software code and database content may be stored on a local computer or on a server.

In operation, a user accesses the system via his respective personal computer, such as PC 106 or PC 108. By activating an application program residing on his computer in conjunction with various application and system programs residing on the server, or by activating a link within a web page, the user selects and retrieves audio, visual or other multimedia content in accordance with the present invention. The following portions of the disclosure describe in detail the system, user interactions with the system via a representative user interface, and processes carried out by a personal computer, server and database in response to the user interactions.

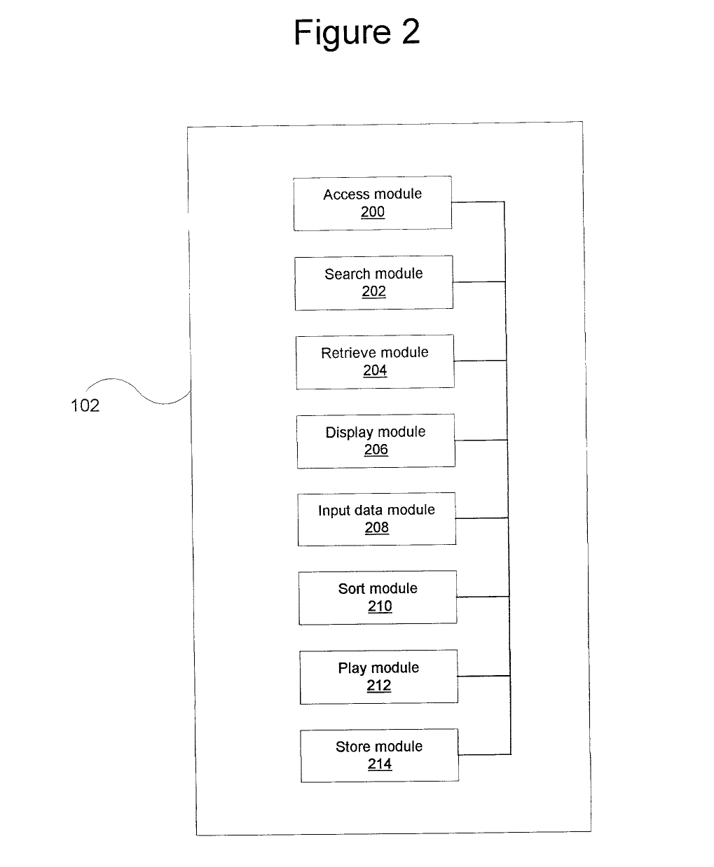

FIG. 2 is a block diagram of software components or modules residing on a personal computer and/or server in accordance with the present invention. The modules, which comprise executable or interpretable software code, will be described herein below with reference to the figures illustrating the structure and functionality of the present invention.

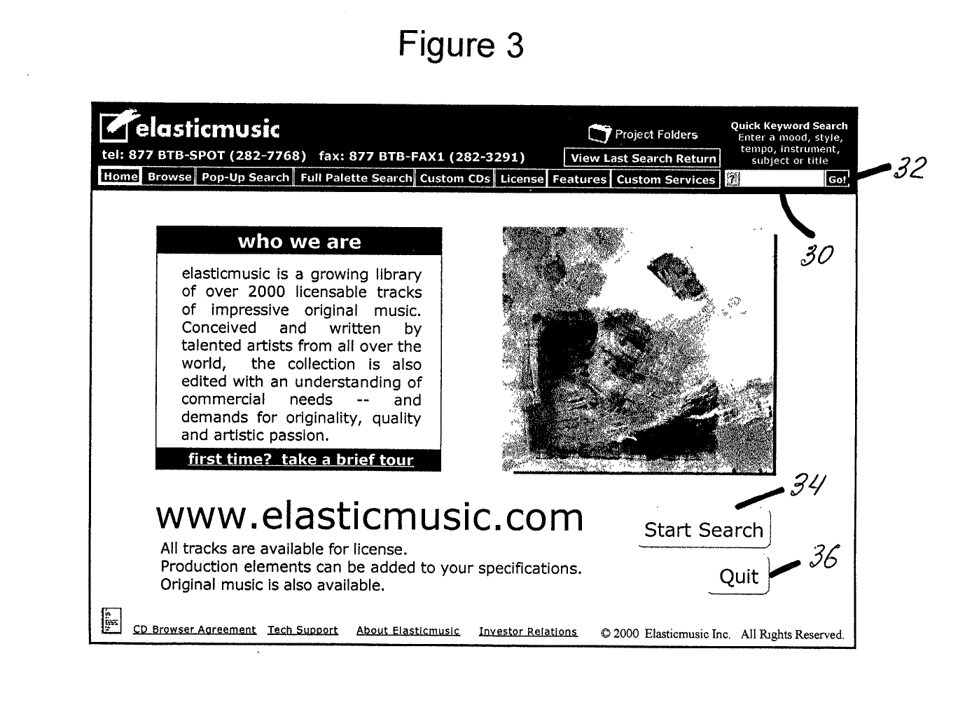

According to one embodiment of the present invention, let it be assumed that a user wants to find a track to incorporate into an advertisement. Using his PC 106, he establishes communication—via network 100—with server 102 that hosts a web site of the present invention. The web site is typically accessed by entering its Universal Resource Locator (URL) address in a browser program utilizing FTP protocol, for example. The server responds with HTML-based documents representing the web site. In particular, its home page is displayed initially, as illustrated in FIG. 3.

While not shown in FIG. 3, a log-in procedure may be initiated to allow only registered users access to the web site contents. In this regard, the user may be requested to enter his/her username and password or any other identifier for authorization and confirmation. The entered information is transferred to the server and checked against the pre-stored information in the database, or alternatively, checked locally at the personal computer. Namely, after the entry of the access information, the server verifies the entered information by cross-referencing it against the registered user information stored in the database. If the entered information is valid, the access to the system is allowed. If, however, the entered information does not correspond to the database-stored information, an error message is displayed on the screen of the user device (PC 106 or PC 108), and the user is invited to re-enter his/her access information.

If the registered user identification information is confirmed or, alternatively, if the registration is not required, the user gains access to the system. The above-described access functions are performed by access module 200 (FIG. 2) running on the server in conjunction with the system software, as well as in conjunction with application software running on the personal computer.

FIG. 3 is a graphical representation of screen display showing a home page of the web site according to the present invention. As shown in the figure, the user may perform a quick keyword search by entering any keyword into field 30. A keyword may represent the desired music or video by a mood, style/genre, tempo, subject, title, and ID, among other things. The search may be conducted with multiple keywords separated by “plus” sign to get an “AND” search. The search feature also includes an omit function which allows the user to enter what they do not want to return in the find, either as a single parameter or in combination with other parameters that the user wants omitted. Additionally, the user can combine find and omit functions, such as in a music search example “jazz but not fast” or in a video example “quick edits and street scene, but not a narrow street”, Once the keyword is entered, the user activates software button 32 “GO” using any input device, such as a mouse, keyboard, touch screen, etc. The request—in a form of the entered keyword—is then transmitted to the server—which accesses the database and retrieves the results, if any, for display on the personal computer.

Each multimedia item is profiled individually by an experienced artist, musician, [symbol] e with appropriate knowledge for the media type. Each [symbol] has its own record in the database that contains more than one field of data related to that item, cataloguing it with a variety of descriptors.

The keyword search function allows a user to locate an item or group of items with any word, number or symbol that exists in the profile of that item. Data entry for each piece is entered into separate fields, with one or more descriptors for each parameter type. The data from these fields is concatenated using a calculation that combines the text elements together into one field. When the user enters a descriptor into the keyword search field and executes the search, any item containing that descriptor in its concatenation field becomes one of the found items of the search return.

To reduce the likelihood of the user getting a null return from entering a word in the keyword search field that is not used in the descriptors, an additional concatenation field has been populated to include synonyms for the descriptors included in the item's profile. For example, “frenetic” may be in an item's profile, but a user may enter “manic”. Even though “manic” was not entered in the data entry profile for the item, appropriate synonyms are assigned to each main descriptor, allowing a user's entry of the synonym to trigger the selection of the item. One solution to designating the synonyms that are valid for a main descriptor is manually or with an automated script to enter a main descriptor word in a thesaurus program's entry box, execute the search for synonyms and copy the synonyms to a “synonyms” field which is part of the multimedia item's profile. The thesaurus program can be integrated within the database or each main descriptor can be pre-programmed to link to appropriate synonyms. The search return display may include the word entered by the user and the synonymous word that it corresponds to which was entered by the data entry profiler. When a word entered by the user has more than one meaning, a user interface may offer the step of asking the user which meaning is intended (including the related synonyms for each meaning for clarification). Once the user chooses the meaning intended, the search completes with that synonym string and executes a return.

The user can select to perform an “ALL” search or an “ANY” search. When “ALL” is selected, all the parameters the user enters must be contained in the item's profile for the item to qualify. When “ANY” is selected, the item qualifies if any of the user entered parameters are contained in the item's profile.

The user may also use the keyword search in conjunction with any of the other available search methods, such as pop-up search, palette search, parameter wheel search, etc. These other search methods are described hereinbelow.

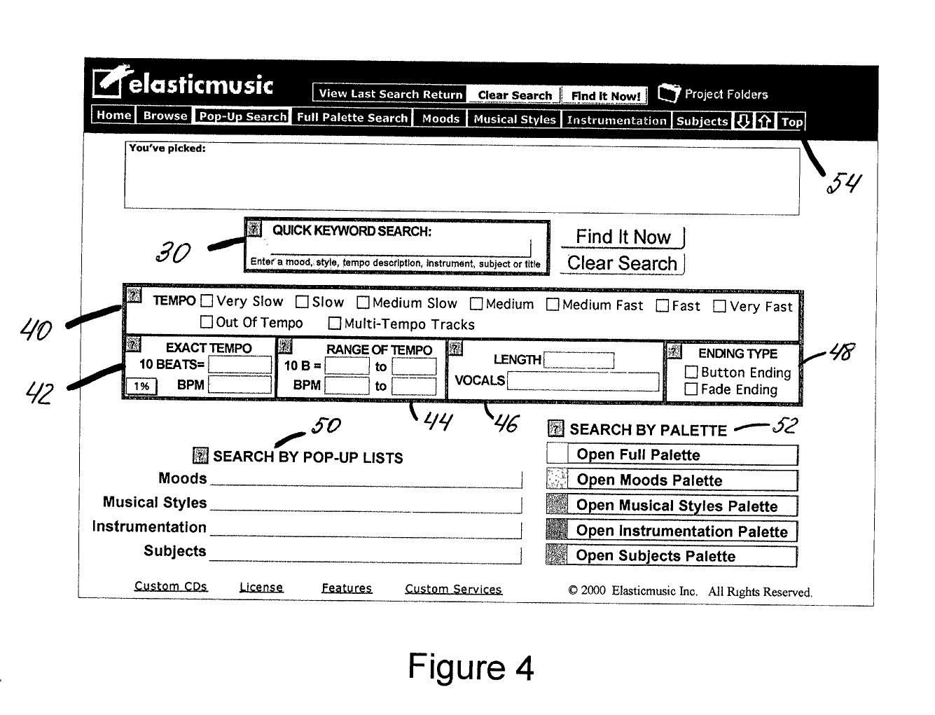

As an alternative to keyword search, the user may initiate a full search function by activating software button 34 “Start Search”. A new web page is then displayed on the computer monitor, as shown in FIG. 4. To exit the web site, the user activates software button 36 “Quit”.

FIG. 4 is a graphical representation of screen display showing a pop-up search page according to the present invention. Once again in this window, the user may carry out a quick keyword search by entering keyword(s) into field 30. In a full search, the user is presented with several parameters related to desired multimedia content. This search feature also includes an omit function which allows the user to enter what they do not want in the search return, either as a single parameter or in combination with other parameters that the user wants omitted As in the keyword search, the user can combine the find and omit functions.

Details of Search Scripts

The user enters search criteria desired into the appropriate parameter categories. Each parameter category has its own separate entry field. That category's user entry field is actually a “global” field (not related to any one record), which is a holding field for the user's entry of that category's parameters. As the user hits the “Find” button, the database enters find mode and the information from each user entry field is pasted into its corresponding field where the data that is being searched actually resides (“populated field”). In some cases calculations are performed on the data that the user enters before it is pasted into the populated field.

A simple example:

1) User enters “happy” into the global moods field (“user enters moods” field).

2) The database goes into find mode and pastes “happy” into the field where the list of moods for that item are located (“populated moods” field).

3) The find is executed and all the items that have “happy” in the “populated moods” field are included in the search return.

Many of the “populated” fields contain the exact data that the data entry person profiling the item entered. For example, the “populated moods” field contains all the moods that the person profiling entered as corresponding to the item. In some cases calculations were performed on the data entered by the profiler to arrive at the final data in the populated field for that parameter category (as is the case with length and tempo fields explained later).

Omit

The omit feature in the invention is implemented in the following way. The user is instructed to enter an omit command in the keyword search field in the format “x, not y”. After the user hits the “FIND” button, a script enters find mode, pastes any parameters before the “not” into the “populated keyword” field, (as is typical in a usual keyword search), and parses out any word(s) that come after the word “not”. Then the word(s) after “not” are pasted into a new find command with omit selected.

In Filemaker Pro®, the script proceeds as follows: 1) enter find mode, 2) enter the desired search criteria, 3) execute the “New Find” command, 4) enter the omit criteria with the omit box selected, 5) execute the find. The program omits any items that contain the text to be omitted in the item's profile.

When the user wishes to enter a parameter to be omitted via the palettes, parameter wheels or pop-up lists, the user enters the parameter he/she wishes to find, then hits the “omit” button (not standard to Filemaker Pro®, but specific to this invention's interface), then enters the parameter via pop-up list, etc. When the user presses the omit button, the user is brought to a layout containing fields to hold omit parameters only. The user specified omit parameters become part of the search criteria.

Tempo

One of the parameters is tempo 40. As shown in FIG. 4, the user may select a desired general tempo for a track from a predetermined list of choices, such as “Very Slow”, “Slow”, “Medium Slow”, etc In addition, the user is given an option of retrieving pieces that match a more specific or exact tempo 42 of a pace of a track, video cut, voiceover, etc.

As an example, for 10 Beats Equals (“10B=”), the user counts up ten beats of the desired tempo and times his count with a stop watch. The user counts from 1 to 10, starting the stop watch on “1” and stopping it on “11”. The obtained number, which may be in single digits, in tenths or in hundredths of a second for greater accuracy, is entered by the user as a parameter. It is understood, of course, that 10 beats are selected as an example, and any number of beats may be selected for timing.

The user may also request a track or video cut on the basis of tempo measured in Beats Per Minute (BPM), a music industry standard for describing tempos. For example, Slow tempos typically range from 40-90 BPM, medium tempos typically range from 90-150 BPM, and fast tempos typically range from 150-350 BPM.

The search return contains the BPM and 10B equals values for a track or video cut. By glancing at those numbers in the search return, the user gets a general feeling of the pace of a piece before playing or downloading.

“10B=” and “BPM” Calculations

The 10B=(“10 beats equals”) value for each item is ascertained by the data entry profiler by timing with a stop watch 10 beats of the piece of music. (A video footage clip also has a pace created by the pace of the edits, which creates a musical beat, and can be timed with 10B= as well). The profiler clocks the 10B= value 3 times, averages the 3 values, and enters the 10B= value in hundredths of a second (a stop watch displaying hundredths of a second is used.)

When 10 beats of a track takes up exactly 5.00 seconds, it is progressing at 120 beats per minute (or BPM). When x is equal to the 10B= value (time in seconds that ten beat takes), 600/x converts the 10B= value into BPM In this manner the BPM of a track can be calculated, once the 10B=value is clocked manually For tracks with a single tempo, for example, if the 10B= value is 4.00 seconds, then the BPM value is 600/4 (150BPM).

If a track speeds up as it progresses, for instance from 120BPM (at the start of the track) to 150BPM (at the end of the track), the value of 10B = at the start of the track would be 5.00 seconds, and the value of 10B=at the end of the track would be 4.00 seconds. Thus the tempo of the track ranges from 120-150 BPM or 5.00-4.00 10B=(10B= and BPM are inversely related.) The profiler enters the lowest 10B= value of the track into the field “10B= Low” and the highest 10B value of the track into the field “10B= High”. A script automatically calculates the corresponding BPM values (600/10B= value) and enters them.

Once the profiler enters the 10B= low and high values and the BPM low and high values are calculated, another script populates the “10B= pool” and the “BPM pool” fields to include, in this example, every value between 120 and 150 in the “BPM pool” field, and every value between 5.00 and 4.00 in the 10B= field. The “BPM pool” field in this case would contain 120, 121, 122, etc. up to and including 150. The “10B= pool” field in this case would contain 5.00, 4.99, 4.98, etc. down to and including 4.00. When the user is searching, if the BPM value the user enters is contained in the “BPM pool” field for an item, the item will be included in the search return, and similarly for 10B=.

After all the data entry is complete, the “BPM pool” field is populated by a script with the following logic:

P0 1) If “BPM low”=“BPM high” (there is no variation in tempo), then “BPM pool”= “BPM low”

2) If “BPM low”<“BPM high” (there is variation in tempo), then “BPM pool”=BPM low, BPM low+1, BPM low +2, etc, until the value of “BPM high” is reached

The 10B= pool field is populated similarly, but with some variations

1) If“10B= low“=”10B= high” (there is no variation in tempo), then “10B pool”= “10Blow”.

2) If “10B= low”<“10B= high” (there is variation in tempo), then “10B= pool”= “10B=low, 10B= low+.01, 10B= low+.02, etc, until the value of “10B=high” is reached.

Also included is the capacity for two completely different tempos to be associated with one item, for instance, a track that starts slow, then suddenly jumps into a very fast tempo. In these cases, the 10B= pool and BPM pool for the item is a combination of the values generated by both tempos.

Exact Tempo vs. Range of Tempo

Another search parameter is Range of Tempo 44. To use this parameter, the user enters low and high values to create a range for 10 Beats Equals or BPM values.

If the user enters 130 in the BPM Exact Tempo field, the track described earlier (which started at 120BPM and accelerated to 150BPM) will be part of the search return. If the user enters 110-130, this track will also be part of the search return, because parts of the track are between 110 and 130.

This functionality is achieved in the following way: When the user hits the “FIND” button to execute the search, the database enters Find mode before the search is initiated. Namely, 110 (the value entered by the user in the LOW RANGE field) and 130 (the value entered by the user in the HIGH RANGE field) are pasted into the “BPM pool” field as 110 . . . 130. Then the script performs the search, and this logic occurs: “if any of the numbers between 110 and 130 are found in the “BPM pool” field, include the item in the search return”. The 10B= script works similarly.

Margin of Error

With both 10 Beats Equals and BPM, the user can specify a percentage of margin for acceptable results. For example, if the user selects 100 BPM with 3% margin, the returned search will include tracks, video clips, voiceovers, etc. that are between 97 and 103 BPM. If an exact tempo needs to be matched, the pop-up menu in the lower left comer of the “EXACT TEMPO” box should be changed to “EXACT”.

This search functionality is possible because of the following structure: If 3% margin of error is selected, the same search function as described in the EXACT TEMPO vs. RANGE OF TEMPO section is performed, except instead of searching in the field “BPM pool”, the field searched is “BPM 3% pool”. The “BPM 3% pool” field is populated by taking the “Low BPM” value minus 3%, and the “High BPM” value plus 3%, and using these results as the new “Low 3% BPM” and “High 3% BPM”. The “BPM 3% pool” is populated from the “Low 3% BPM” and “High 3% BPM” fields exactly as the “BPM pool” field is populated from the “Low BPM” and “High BPM” fields (described above.)

All other percentage of error “BPM pool” fields are populated in a similar manner as the “BPM 3% pool” percentage of error field.

The “10B= pool” percentage of error fields are populated in a similar manner as the “BPM pool” percentage of error fields, except that 10B= values are always rounded to the nearest hundredth of a second.

Entry Error Control

A script corrects for a user that enters a higher number in a “Low” field than he/she enters in the “High” field, both for 10B= and BPM. Before pasting the values and executing the search, the script ascertains which number is greater and places the correct number in the correct field.

Length and Vocals

Yet another search parameter is Length and Vocals 46. The multimedia content stored in the database have been created in several basic lengths: the long (which is over a minute and a half long), 60 seconds, 30 seconds, 20 seconds, 15 seconds, etc. Some titles are offered in a variety of lengths, and this feature will return edits designed to work with the user-entered length. If the user enters, for example, 60 seconds, edits that are approximately 60 seconds in length are returned as search results. That is, search results are obtained that contain selections equal to or longer than 60 seconds that were intended to be faded at 59 seconds as a complete spot. For instance, the search with 60 seconds may return an edit with 1 minute and 12 seconds. This edit was designed to work faded at 59 or 60 seconds, but also includes extra music at the end after 60 seconds in case a section needs to be edited out internally and still have music left to complete at full 60 seconds. With many of such “over length” edits, the user can start the spot after the piece's intro or cut out a bar to make an important “hit point” and still have a complete 60-second piece of music.

Each item has more than one data entry length assigned to it. First, “exact length” is the precise timing of the item rounded to the nearest tenth of a second. Second, the “client length” puts each item into a category of lengths typically used in the industry and easier to search by. For example, in the current embodiment of the invention, “client length” (displayed to the user in the search window simply as “length”) is populated with a script as follows:

If exact length is :01-08.5 (sec), then “client length” is “:05”

If exact length is :08.5-13.5 (sec), then “client length” is “:10”

If exact length is :13.5-18.5 (sec), then “client length” is “:15”

If exact length is :18.5-28 (sec), then “client length” is “:15”

If exact length is :28-58 (sec), then “client length” is “:30”,

If exact length is :58-1:28 , then “client length” is“:60”.

If exact length is over 1:28 , then “client length” is “Long”.

Regarding vocals, this feature allows the user to search for pieces that have vocals with lyrics, pieces that have vocals without lyrics (scat, chants, shouts, etc.), or pieces that have no vocals. Additionally, the user can specify the language, for example English or French, as a parameter in the search, This is a useful tool as the status of vocal is a common criteria used when describing the music desired.

Ending Parameters

Still another search parameter is Ending Type 48. The user can select button endings or fade endings. Button endings have a definite conclusion and feel like a complete ending, whereas fade endings give a sense that the music continues past the end time. It will be appreciated that the user may search for fade ending with a bonus button ending. Some edits are designed to end with a fade, but also include a button ending after the point where the fade would take place. For example, a fade ending edit designed to fade at 30 seconds may include a bonus button ending at 36 seconds to allow the user to create a button ending from that edit by starting later into the edit or editing out music internally. Type of ending is often an important consideration for advertising professionals in commissioning original music compositions.

Other Search Parameters

FIG. 4 further illustrates that several other search parameters relating to the multimedia content stored in the database are presented to the user such that the desired piece can be quickly and accurately located. Search By Pop-Up Lists 50 allows the user to select in this case moods, musical styles, instrumentation and subjects as desired in a track, video clip, etc. The user can enter multiple parameters within a category, and/or multiple parameters in different categories. For example, by clicking on moods field, the user is presented with a pop-up list that includessuch moods as “Abandoned/Rejected/Disappointed”, “Intimate”, “Love”, “Wild”, etc. The user may select from a pop-up list of musical styles that include “Big Band”, “Metal”, “Reggae”, etc. Using the instrumentation field, the user may search for a track on the basis of various instruments/instrumentation such as accordion, electric guitar, French horn, etc. The user may also select from a pop-up list of subjects such as animation/cartoon, humor, sci-fi, etc. to look for a track or other multimedia content. Mood, instrumentation, style and subject are examples of descriptor categories that could be used. It is understood, of course, that these features apply to any category that a user might enter to search for content. All the pop-up menus are accessible from one page.

Additional Search Methods and User Interfaces

Additional search methods and user interfaces are also available to address different creative/work styles. The palettes (52) are implemented here as alternatives to pop-up lists. Thus, moods, musical styles, instrumentation, subjects and other parameter categories contained in the database system, as described above with reference to the pop-up lists, can be selected via the palettes which allow the user to see at a glance a choice of descriptors available As in the pop-up lists, with palettes the user can select multiple parameters within the same category. For example, if a user enters “happy” and “playful”, items will come back in the search return that are both “happy” and “playful”. The user may also specify parameter(s) to omit as described earlier. Furthermore, palettes have criteria organized in such a way whereby like criteria are positioned adjacent to each other. The user may choose to use one or more search interface during a search; data specified in one interface will be preserved and displayed as user switches between interfaces, and the executed search will use all parameters specified to retrieve multimedia content.

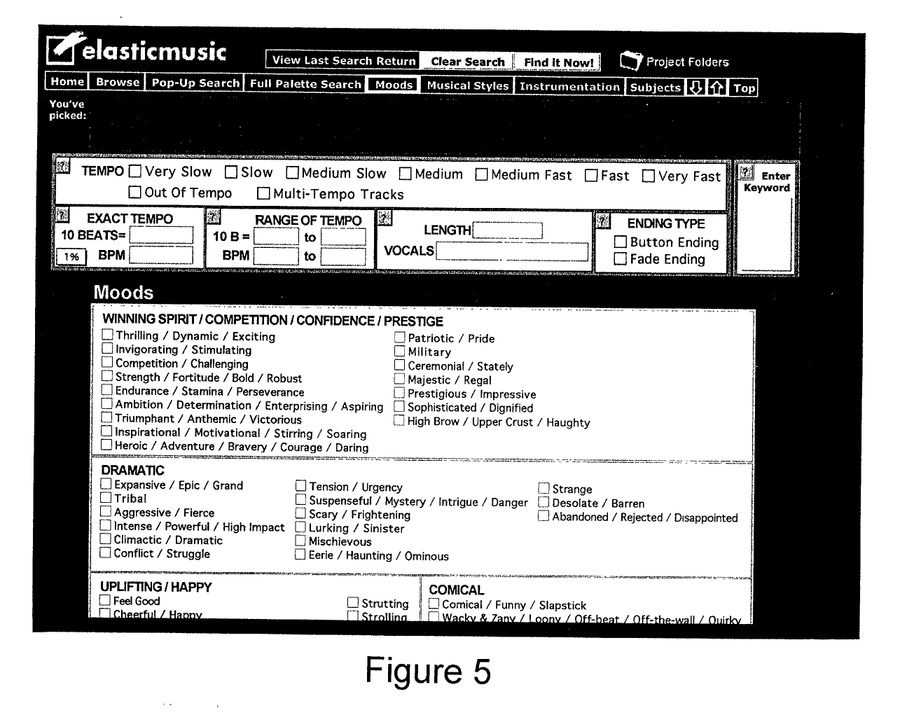

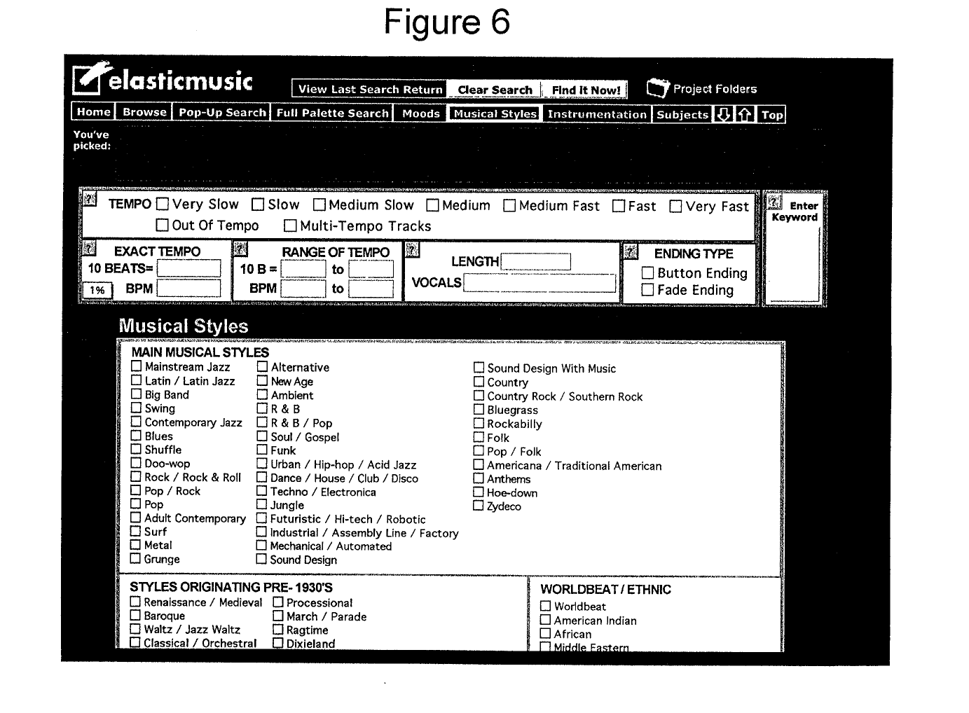

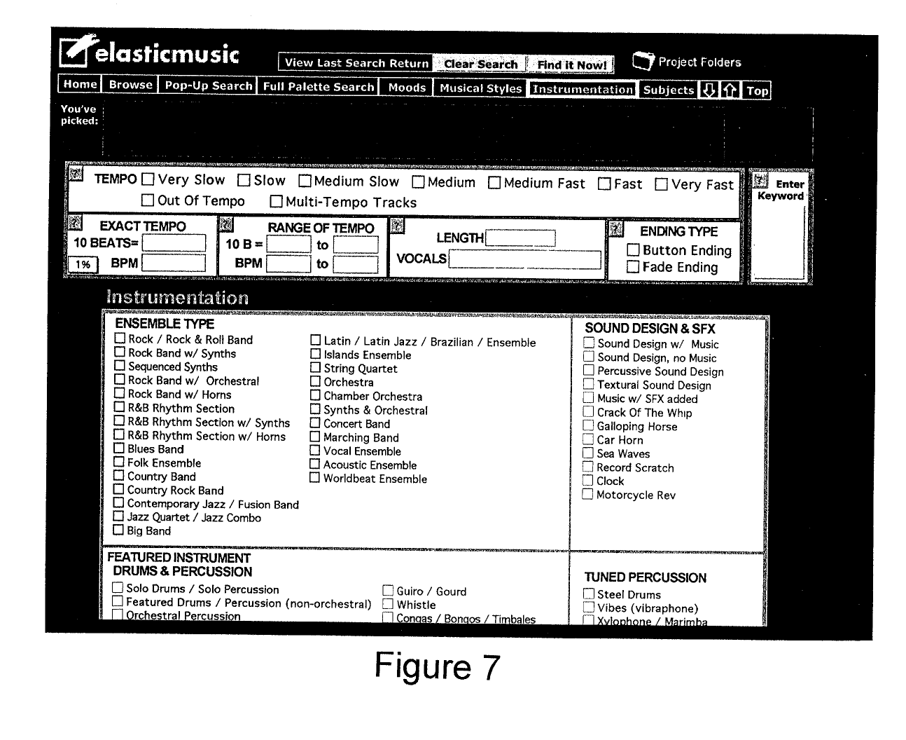

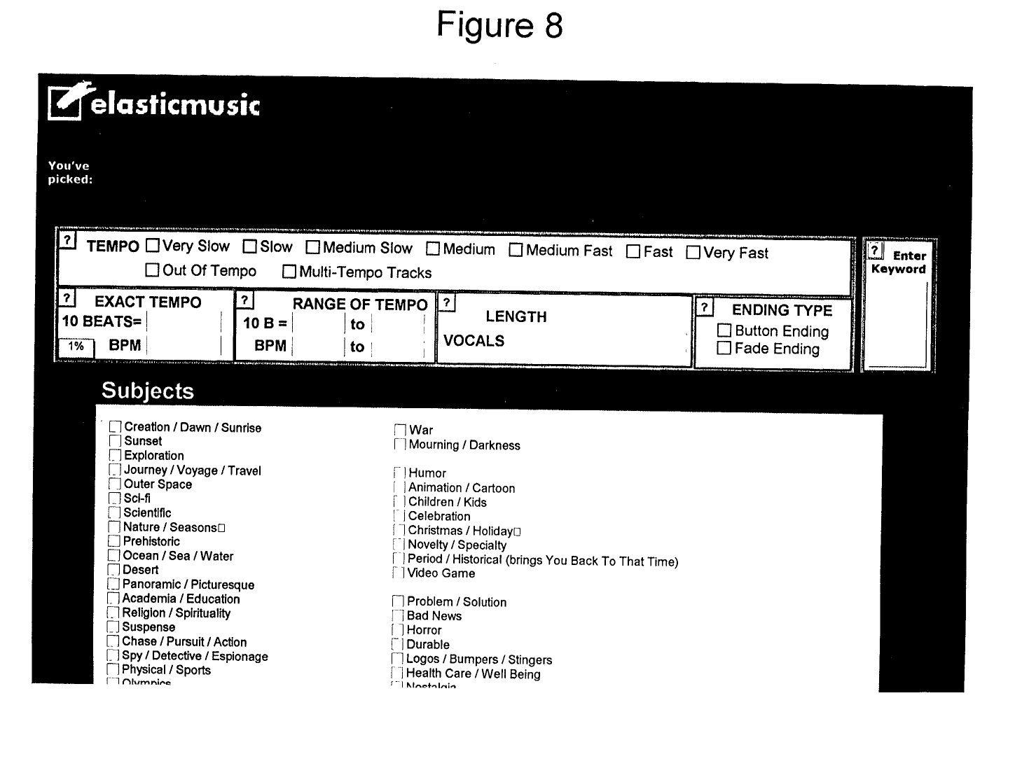

FIGS. 5-8 are graphical representations of screen displays showing moods, musical styles, instrumentation, and subjects palettes, respectively, according to the present invention. The user can also view all the palettes by selecting a full palette option, whereby moods, musical styles, instrumentation, and subjects palettes are displayed on one screen and a vertical scroll bar is used to scroll up and down the screen. A user can select to view a specific palette or specify a combination of palettes according to user preference. On-screen text descriptions or graphical representations of the possible palettes are linked to scripts which change the layout to the appropriate view when selected by the user with a single action (click).

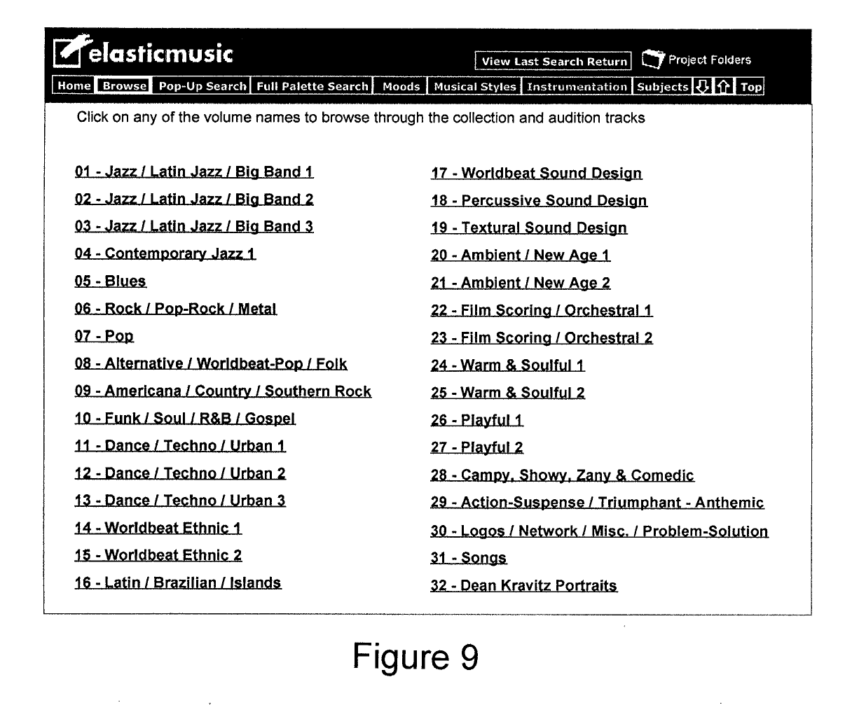

Horizontal menu bar 54 contains, among other things, the browse function (FIG. 4). If the function is activated using, for example, a mouse cursor, the user is presented with a new page. FIG. 9 is a graphical representation of screen display showing a list of multimedia items for browsing according to the present invention. On this page, the user has yet another method of searching for a desired track. By pointing and clicking on any of the presented items, the user can browse through the available tracks organized by volume and category, such as tempo, subject, instrumentation, mood or style criteria. For example, by clicking on volume 31 —Songs, the user is taken to another page displaying tracks falling into the songs category. The categories are organized with similar criteria grouped together. For example, “Jazz” volumes are next to “Blues” and “R&B”, and “Playful” volumes are next to “Humorous”.

Parameter wheels are yet another option presented to the user to search for multimedia content. As an alternative to the pop-up lists and palettes, parameter wheels include moods, musical styles, instrumentation, subjects and any other pertinent parameter categories. Similar to palettes, multiple parameters can also be entered in the same category or in different categories. The omit feature described above can also be utilized in the parameter wheels. Similar to palettes, wheels provide visual indication of available criteria organized according to their similarity. A user can select to view a specific wheel or specify a combination of wheels according to user preference. On-screen text descriptions or graphical representations of the possible wheels are linked to scripts which change the layout to the appropriate view when selected by the user with a single action (click).

Parameter “wheels” are used to help visualization of the concept, but the parameters may be organized in a square, rectangle, triangle, oval, or any other geometric shape, to allow similar parameters to be visible next to each other. To enable parameters to be displayed in specific shapes, each parameter choice in a category can, for example, have its own check box or radio button to allow flexibility in graphic design.

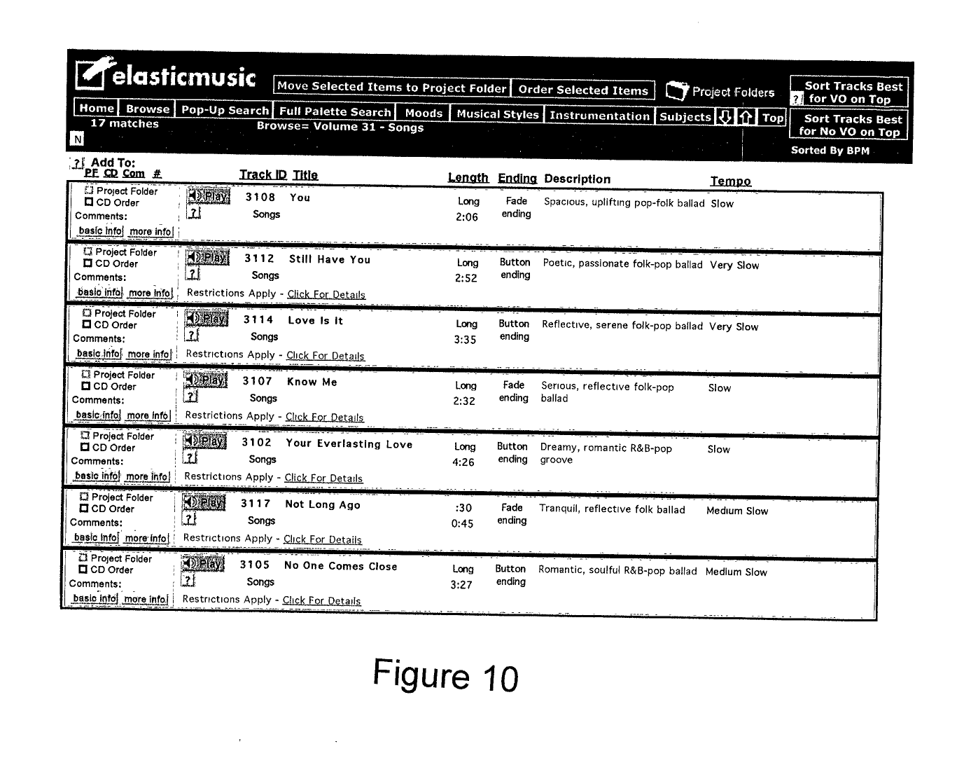

FIG. 10 is a graphical representation of screen display showing a list of tracks in a particular volume as selected for browsing according to the present invention. As shown in the figure, each item is displayed separately and the song can be played in part or in its entirety by activating a “play” button. The play function is performed by play module 212 (FIG. 2) running on the server in conjunction with the system software, as well as in conjunction with application software running on the personal computer.

The user is given the option to set preferences as to what the “play” button will activate. In the present embodiment of the invention, for example, the user can choose which plug-in, and/or which quality level of audio to preview, as well as the location of the audio (that is, does the user want to read audio, for example, from the Web, from the CD-Rom in their computer, from a local or networked hard drive containing the audio, or another location?). These options offer flexibility to meet the user's situation and needs for a particular project. In one embodiment of the invention, these choices are made in a separate area other than the search return list, freeing up space on the search return page, but these options could also be available from the header or footer of the search return page, or any other location on the search return page.

Each format and location have a different address. For instance, when the Track ID for an item is 0101, and the name of the item is “Fun Day”, a QuickTime® file on the user's internal hard drive might have the address:

MyHardDrive:QuickTimeFiles:0101FunDay.mov and a RealPlayer® file on the web server might have the address. www.WebServerCompany.com/MyServer/RealPlayerFiles/0101FunDay.ra

Every time a user presses a “PLAY” button to play an item, in any of the windows, the PLAY script checks what format and location the user has chosen in the audio preferences page and plays the appropriate file at the appropriate address. For example, if “Play QuickTime From My Hard Drive” is selected by the user in preferences, then the audio file at the location “MyHardDrive:QuickTimeFiles0101FunDay.mov” will be opened and begin to play. If “Play RealPlayer From The Web” is selected, when pressing PLAY for that same item, the audio file at the address “www.WebServerCompany.com/MyServer/RealPlayerFiles/0101FunDay.ra” will be opened and begin to play. A field is made available for the user to enter specifics regarding the address of his/her audio source. When appropriate to the user's preferences, that field is included in the calculation that is automatically called upon when the user hits “play”,

Windows and Mac have different protocols for opening applications and addresses of files, so each format type requires its own if/then statement for both Mac and Windows.

The address corresponding to each item is automatically generated with a script that compiles the address with the following elements: ServerAddress/“ContentsOfrracklDField”/“ContentsOfTrackTitleField ”.

Automation of Play Functions

The user can also choose or enter the number of seconds preview desired for each selection in the list, for instance, 4 seconds, 15 seconds, 30 seconds, or any other user specified number, which will cater to the user's work style or needs for a particular project. The user can also choose to play the entire list,(so the software plays all the tracks without the user needing to activate for each track) and can specify the order in which the tracks are played.

Every time a user presses a “play” button, the PLAY script checks to see if any automation features are selected in the preferences page and plays accordingly. For example, if the user has selected, “play only first 10 seconds of each item”, the following loop plays: the first item's audio file is opened, the current time is captured, and at current time +10 seconds, the script will progress to the next record and open the next file.

If the user has selected, “play the full length of every item in the found set”, the following loop plays: the first item will open, the current time will be captured, at current time +the exact length of the item the next item will be opened and play

In addition to choosing the number of play preview seconds, the user can also automate playback by choosing for the computer to “announce and play”. With “announce and play”, the user sets preferences as to what information about the track (which field in that item's profile) will be provided by the computer, and the user can choose to hear that information before or after the item plays.

Track Downloads

In addition to previewing any track, although not indicated in the drawing, the user can download a track from this window. The user has the option to download a single item at a time or a group of user-specified items with one click. The automated download of multiple tracks is achieved with a script that initiates the download function for the first selected track, then advances to the next selected track and initiates that download, and so on, until the download command is executed for all the selected tracks.

Track E-Mails

The user is also able to e-mail tracks and information about tracks from their selections in the search return, project folder, media order, license order or any other storage module. Once the user has selected one or more tracks he/she wishes to send, the user can activate the sending of these tracks, and can specify a new e-mail address or one that is stored in the system for the track to be sent to The recipient of the e-mail receives, in most cases, a link to play these tracks, but the sender or the receiver can also specify if they would like to download the multimedia item file to their system. The same format preferences can be set separately for received and sent e-mail documents. The recipient may receive a variety of links, each with different preferences pre-assigned, or may add the preferences once he/she arrives to the link's destination. With preferences pre-assigned, the links lead the recipient directly to playing the item. With preferences not pre-assigned, the links lead to a page where a recipient can select preferences before playing the item.

The sender can send the entire (or selected) contents of a search return, project folder, media order, license form or other storage module, and the recipient will be able to see all information regarding the multimedia item in the many different display formats discussed earlier, and can play the item with the play preferences described earlier. The recipient also has the ability to forward the links back, with extra comments, or add extra multimedia items to send back to the sender or to another party. The sender has the option to send the links and information about the tracks in such a way that it is a simple textual e-mail, or can choose to send in the format of a Word®, PDF®, or other widely-accepted format, to enable the viewer to see more closely the visuals that the sender sees. In addition to sending a PDF of the appropriate screens in the e-mail, the sender also has the ability to send a file in Filemaker Pro® formats or another database or spread sheet format, enabling the user to manipulate the information and links to the items easily. Another option is for the sender to send a cluster of databases that represents identically or very closely the original database structure. This offers the recipient the ultimate control in manipulation, sort, display, storage, play and other options available specific to the invention.

Moving Items from One Location to Another

The search return page allows the user to send or store the content to various other areas all from one page, depending on the project needs of the user. For example, in the current embodiment of the invention, each song can be added to a CD/media order by checking the CD box next to the tracks to be included in a custom CD, DAT, cassette, computer file or any other type of media order to be sent to the user via mail or e-mail. If the user checks the Project Folder box, the track is moved to a project folder. As further shown in FIG. 10. the user can enter comments to his selection in the comments field. When a track is sent and stored in another area, any user-entered comments will be transferred along with that track's descriptive information. Additionally, although not indicated in the drawing, the user can mark a track to be moved to a license application form. CD/media orders, project folders and license applications are only representative examples of storage modules that can be made available for users to send information to. A user may also specify items to be deleted from the display of a search return.

When the user presses the “move to project folder” button, every item that has “project folder” selected is moved at once to the project folder. The project folder the user desires to move items to is chosen by the user in “preferences” or in an interface window that appears after the “move to project folder” button is pressed. At that time, the user is also given the option to create and name a new project folder to move the items to.

For each item to be moved, a new record is created in the PROJECT FOLDER ITEMS database, and the Track ID, user comments and other pertinent fields are imported into PROJECT FOLDER ITEMS. Each of the newly created records in PROJECT FOLDER ITEMS is given a Project Folder ID serial number. The PROJECT FOLDER file contains a portal that displays information for each of the items in that folder, reading that information from PROJECT FOLDER ITEMS. A similar import is executed when moving items to a License Form, CD/media order or any other storage module.

Sorting

By clicking on the PF button in the Add To section, the user can sort the selected songs based on their inclusion in the project folder. Namely, by activating the PF button, all the tracks checked with “Project Folder” come to the top of the list. Similarly, by clicking on the CD button, all the tracks checked with “CD Order” come to the top of the list, sorted by the order specified in the “Sort Order” box to the right of the CD Order check box. And by clicking on comments, all the tracks with notes in the “Comments” box come to the top of the list.

Conversely, all the tracks without checks or comments drop to the bottom of the list. The check boxes and comments box are used to help organize favorite tracks during a session.

One embodiment of the invention illustrates an example of storage module destinations, but any user entry category may be sorted similarly. The user can sort these with a single action (click), and the sort is reversed with each click on the sort button that follows.

Sorting by Density/Complemtary Qualities

Furthermore, the multimedia content may be sorted according to density or the degree to which a track would blend or draw attention to itself when combined with other sonic and visual elements such as voiceover or visual images. Clicking on “Sort Tracks Best for VO on Top” sorts sparser, more complementary tracks, i.e., tracks that tend to stay out of the way of the voiceover (the spoken word, such as an announcer) towards the top of the list. Tracks with more action and busier melodies drop to the bottom of the list. This is useful when an item searched for is intended to interact with other elements in the user's project. Clicking “Sort Tracks Best for No Voiceover on Top” sorts tracks that feature prominent musical ideas towards the top of the list.

The sort described here is expressed for a specific target audience as “Sort Tracks Best For Voiceover On Top” or “Sort Tracks Best For No Voiceover On Top”. The elements that the items are combined with will vary in different user environments and the name of the sort is likely to change accordingly, but the concept of sorting by the “density/complementary” characteristic of an item remains the same in accordance with the present invention.

This sort is achieved by profiling the “density/complementary” ranking during data entry. Items that are very dense or obtrusive get a higher rating, and items that are sparse or blend well get a lower rating. When the user executes this sort, the items in the list are sorted by the field that contains this “density/complementary” ranking.

It should be noted that the accuracy of human data entry is crucial to the user receiving accurate search results. For subjective decisions, multiple profilers'ranking values are averaged to ascertain a more objective ranking.

Sorting by Relevance

It is also possible for a user to select “Sort by relevance” whereby items that match the user's query most closely are brought to the top of the search return list. For descriptors that lend themselves to relevance rankings, such as mood or style, a descriptor word is given a rating of how relevant it is to the item. For example, if a piece contains no discernable elements of Jazz, it would receive a rating of 0; if a piece contains hints of Jazz it would receive a rating of 1; if a piece has strong Jazz influences but also other significant stylistic influences it would receive a rating of 2; and if a piece has no other significant stylistic influences, but only conjured the style of Jazz, it would receive a rating of 3.

Some parameter categories lend themselves to relevance, while others do not. For instance, when a user searches for a piece by title, he/she is usually looking for a binary response. Either the track includes the words “Fun Day” or it does not. Relevance is not necessarily very useful.

On the other hand, with moods, for instance, relevance is very useful. If a user is looking for an item that is “mysterious”, he/she may want to examine the items that are most “mysterious” first, followed by items that evoke mystery but to a lesser degree. By executing “Sort By Relevance” the search return is sorted so that the parameters entered are checked against each item for their relevance rating with respect to each parameter.

Items that are the most mysterious get a ranking of 3, moderately mysterious items get a ranking of 2, and slightly mysterious items get a ranking of 1, when the item's profile is entered.

When the user activates the relevance sort after a search for “mysterious”, items for which the “mysterious” parameter has a rating of 3 come to the top of the list.

If more than one parameter is entered by the user, for instance, “mysterious” and “cellos”, items with a mysterious ranking of 3 and a “cellos” ranking of 3 (cellos very prominent), come to the top, followed by items where one parameter is ranked 3 and the other is ranked 2, etc. A value is calculated by averaging the parameter rankings Items with the highest relevance average come to the top of the search return list

An alternative method is ranking an item with respect to how many times and how notably that parameter appears in the item's profile. For instance, if an item is called “Jazzy Sax”, and is in the “Jazz” volume, and has “jazz” in its item description, and has “jazz” as a musical style influence, it receives a higher relevance to jazz than if the item just has “jazz” as a musical style influence, but does not have that word in its description, title, volume name, etc. If “jazz” is in the description, the item gets a relevance point of 1; if “jazz” is in the volume name the item gets an additional 2 relevance points; if “jazz” is in the title it gets an additional 3 relevance points. Thus, items with the most prominent occurrences of the word “jazz” are sorted to the top of the list.

These ratings are given by personnel with appropriate experience, and in the case of particularly subjective parameters(such as mood), impressions are entered by more than one person, and the results averaged to receive a more accurate relevance rating and thus a more accurate sort by relevance for the user.

The user can also sort by tempo, title, type of ending, composer, or any parameter that would be useful to a user to organize the search returns. This is achieved in the present embodiment of the invention using scripts linked to on screen graphical representations of the possible sorts. The above-described sort functions are performed by search module 210 (FIG.2) running on the server in conjunction with the system software, as well as in conjunction with application software running on the personal computer.

Display Options

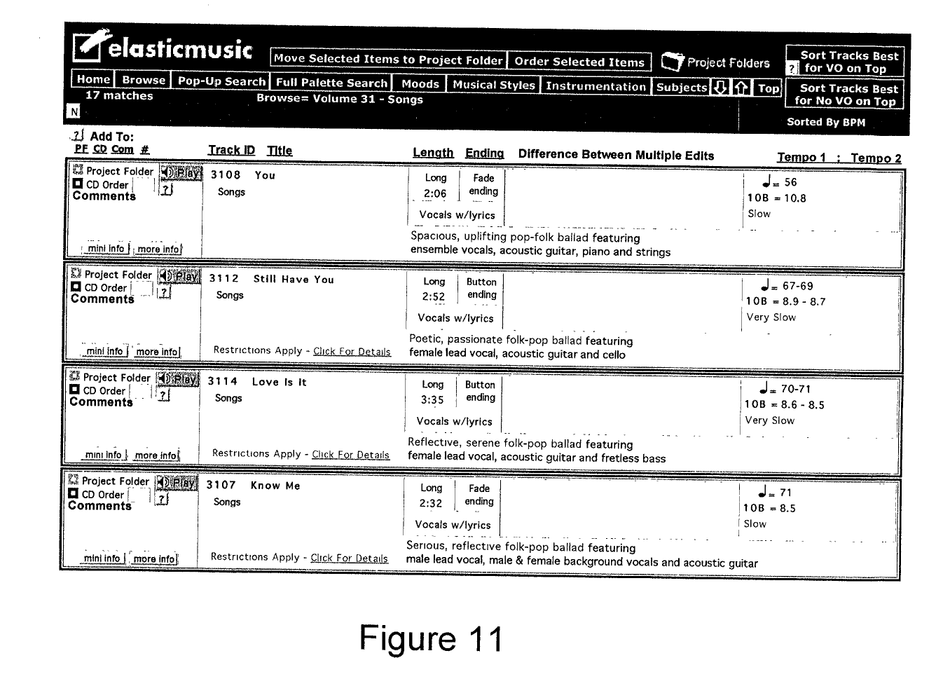

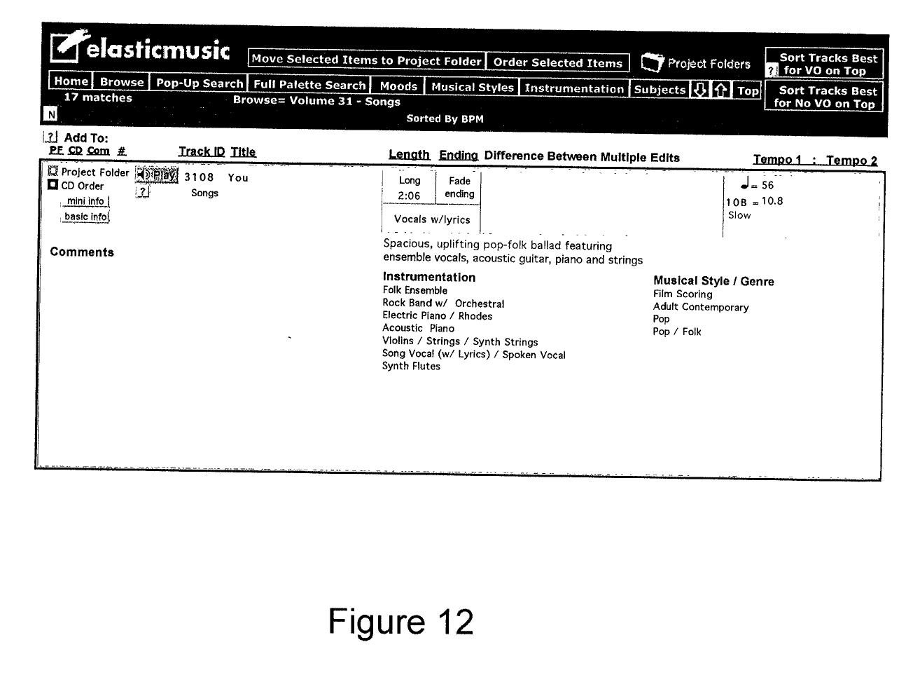

In addition, the user can select how much and which information he/she wants to view about each multimedia item Representative views are mini info, basic info, and more info FIG. 10 shows information about each song in mini info format. More detailed views allow fewer items per screen display and less detailed views allow more items per screen display FIGS. 11 and 12 are graphical representations of screen displays showing basic information and more information views, respectively.

It will be appreciated that search returns, which are retrieved from the database by retrieve module 204 (FIG. 2) running on the server in conjunction with the system software, as well as in conjunction with application software running on the personal computer, are displayed in the same format whether as part of a browse or a search request. The returned items can thus be sorted according to various criteria with a single action (click), played, downloaded, or sent to a project folder, custom order, license application or other destination—similarly in different views.

In addition, the user has the ability to view restrictions for a particular multimedia item in the search return. The listing of restrictions may be used to allow content providers to identify restrictions for the use of a track for specific projects or purposes. For example, ads for political causes or pornography may be objectionable for a content provider and the content provider may not want their content associated with such projects. The user has access to any restrictions that may apply to a particular piece of content from its listing in the search return and from wherever the piece of content may be sent to, i.e. from within a project folder, custom order, license application, etc.

Naming, Storing and Recalling Searches

Each search can also be given a name by clicking on a button. Thereafter, the search criteria or the search return items are stored in the database. This and other storing functions are performed by store module 214 (FIG. 2) running on the server in conjunction with the system software, as well as in conjunction with application software running on the personal computer.

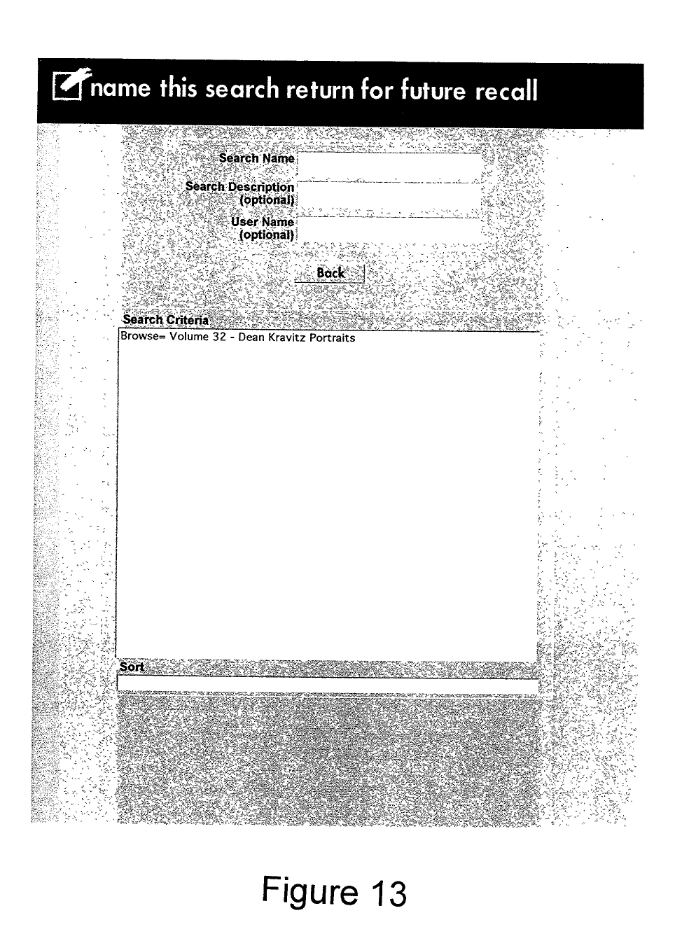

FIG. 13 is a graphical representation of screen display showing a search return template that the user completes to name the search. In addition to the search name, other information can be entered and stored in the database for subsequent reference. These searches can be browsed in the window which lists all the search information from past searches. This search information can be sorted by name of the search, date searched, number of returns found, or person that performed the search, etc. Furthermore, once the user locates a search to recall, that stored search can be recalled with a single action (click).

In one embodiment of the present invention, every time a user hits the “FIND” button to execute a search, all the criteria entered into the global user entry fields are copied to a record in the SEARCH LOG. For example, a user enters “happy” into the “user enters moods” field, and when the “FIND” button is hit, a script pastes “happy” into the “log of moods” field in the SEARCH LOG. The same script also pastes “happy” into the “populated moods” field in the SEARCH file, and brings up the appropriate search return as described earlier. All parameters the user designates to “omit” are copied from the OMIT user entry fields into their respective SEARCH LOG fields dedicated to hold “omit” criteria.

When the user hits “recall search” next to that record in the SEARCH LOG, the database enters find mode, “happy” is pasted from the “log of moods” field in the SEARCH LOG database, into the “user enters moods” field in the SEARCH database, and the search is executed as if the user just entered that information into the “user enters moods” field. When the user hits “clear search”, it clears the user entry fields, but keeps the SEARCH LOG record intact.

Browse commands are treated like searches. Every time the user executes a browse command, to browse a volume of items, that command is logged in the SEARCH LOG to allow future recall. When the user names a search return and adds comments, that information is also stored in the SEARCH LOG, allowing the user to easily locate by title or other pertinent information the correct search to recall.

How Sorts are Stored and Recalled

Sorts for a search return are logged in the “sort type” field in the SEARCH LOG, in the same record as the search criteria for that search return. Every time a user selects a custom sort in the search return window, that sort information is pasted into the “sort type” field for the current record of the SEARCH LOG. The “sort type” field is a record of the last sort chosen by the user for that search return. When the user hits “recall search” next to that record in the SEARCH LOG, after the search criteria are pasted and the find is executed, the sort is recreated from the info in the “sort type” field.

For example, if the user sorts SEARCH RETURN A by Title, ““title” is pasted into the “sort type” field in the SEARCH LOG, next to the search criteria for SEARCH RETURN A.

When SEARCH RETURN A is recalled by the user, after the criteria are pasted and the find is executed, a sort conversion script executes the correct sort. That script contains the logic, in this example: if sort type=“title”, then execute the “SORT BY TITLE” script.

View Last Search Return

The user has the option at any point to recall the last search return. When the “View Last Search Return” button is pressed, the last set of criteria and the last sort type logged in the SEARCH LOG is pasted back into the SEARCH database and that search is executed. Not only is the last search return and sort restored, but the exact location (in Filemaker Pro® expressed as record, layout and portal row) where the user was last working in that search return is also restored. This functionality is achieved as follows: every time a user navigates from a search return page to a non-search return page with a button, the status of the “Current Record Number”, “Current Portal Row Number”, and “Current Layout Number” are recorded, with each number into its own global holding field, thereby saving the exact location where the user was last working. When the user hits “View Last Search Return”, the SEARCH and the SORT are recalled, the exact location where the user was last working on that search return page is restored. The script navigates to the record number, portal row number, and layout number contained in the global holding fields.

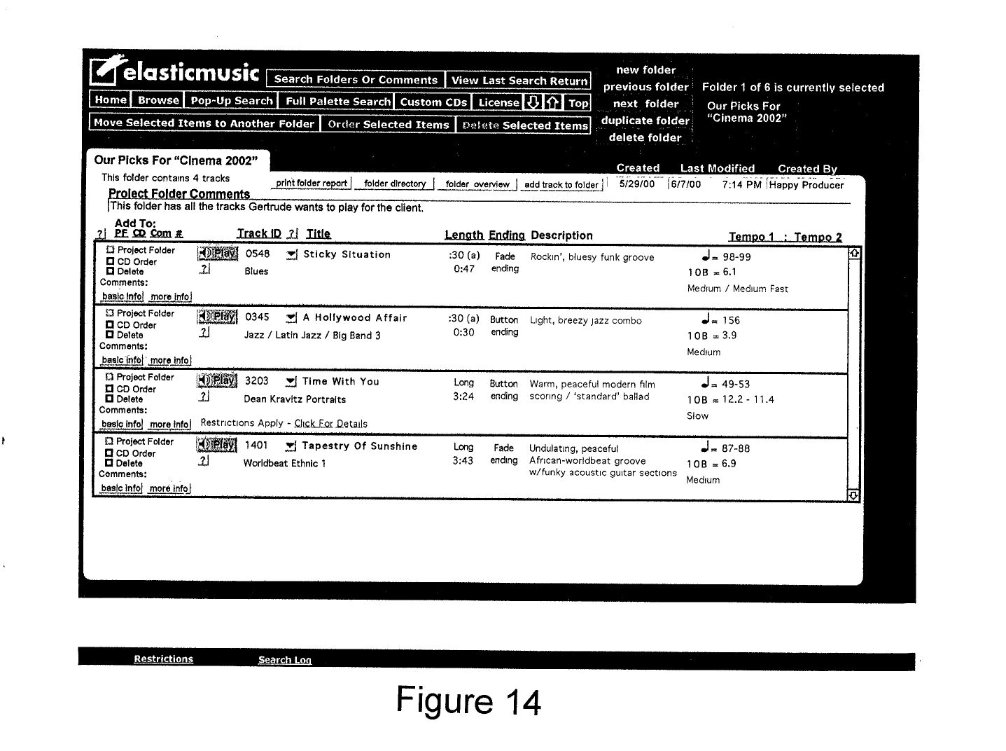

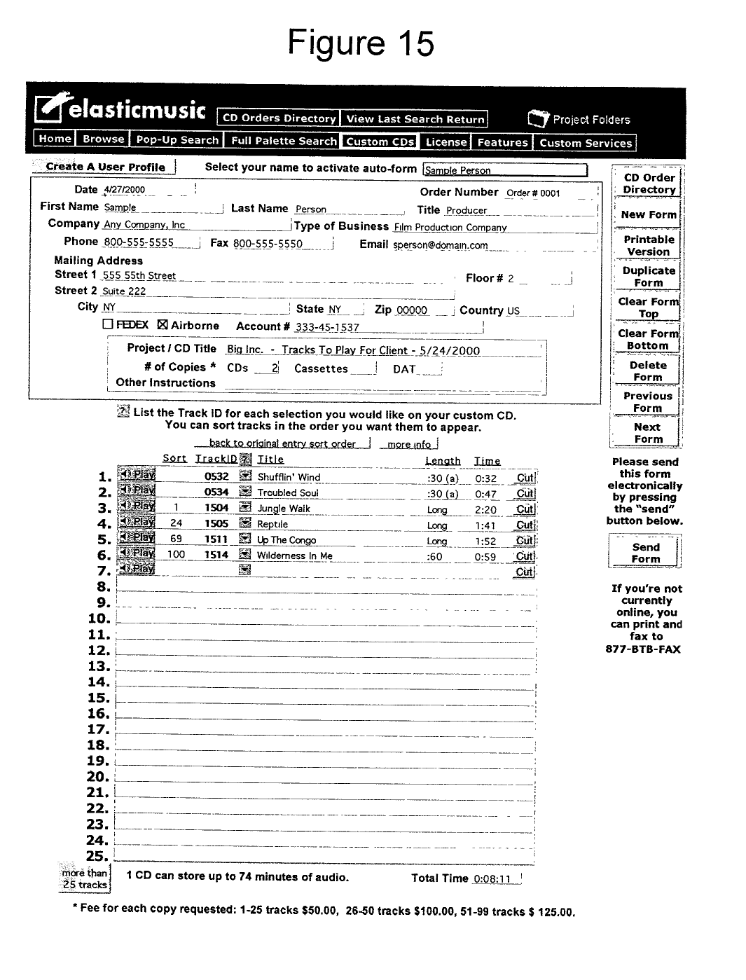

FIG. 14 is a graphical representation of screen display showing a representative open folder in which tracks have been stored under the folder name “Cinema 2000”. All of the sort, display and play options described earlier with respect to search returns can be performed within a project folder. Additionally, items can be moved from a project folder, to another project folder, a media order, license form or any other storage module. The user can also create new folders, delete or copy existing folders. There is also a list view or directory of all the folders which the user can use as an organizational tool. The directory displays, among other things, the date the folder was created as well as date last modified. The user can open any folder from the directory with a single action (click). Such directories are also available in other destinations as well, such as in CD/media orders and licenses FIG. 15 is a graphical representation of screen display showing tracks selected for a custom CD/media order. All of the sort, display and play options described earlier with respect to search returns can be performed within a media order.

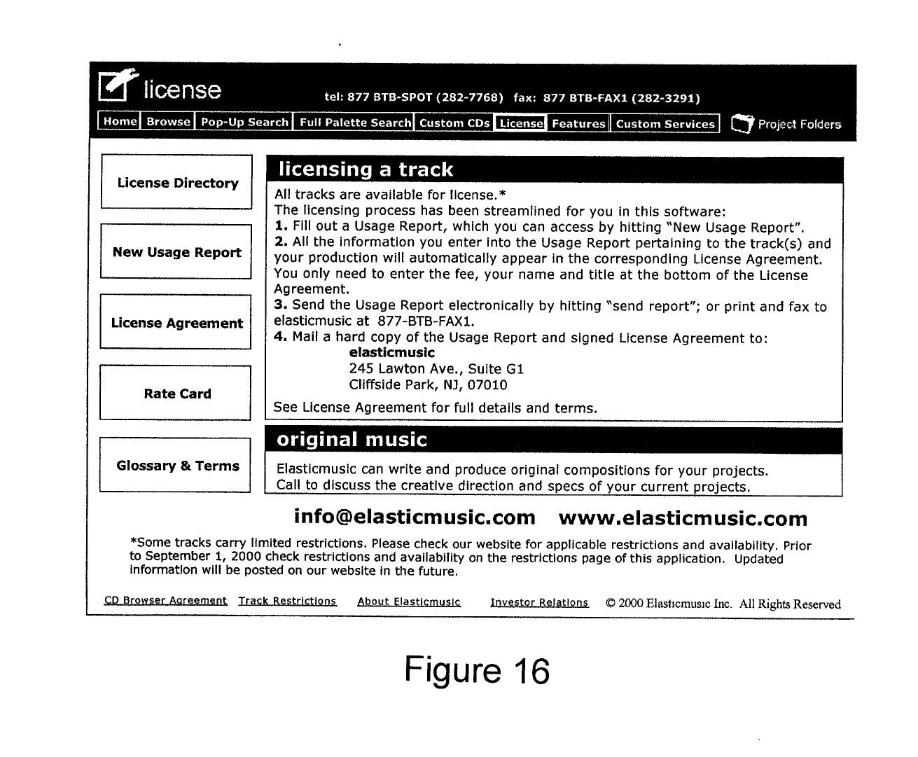

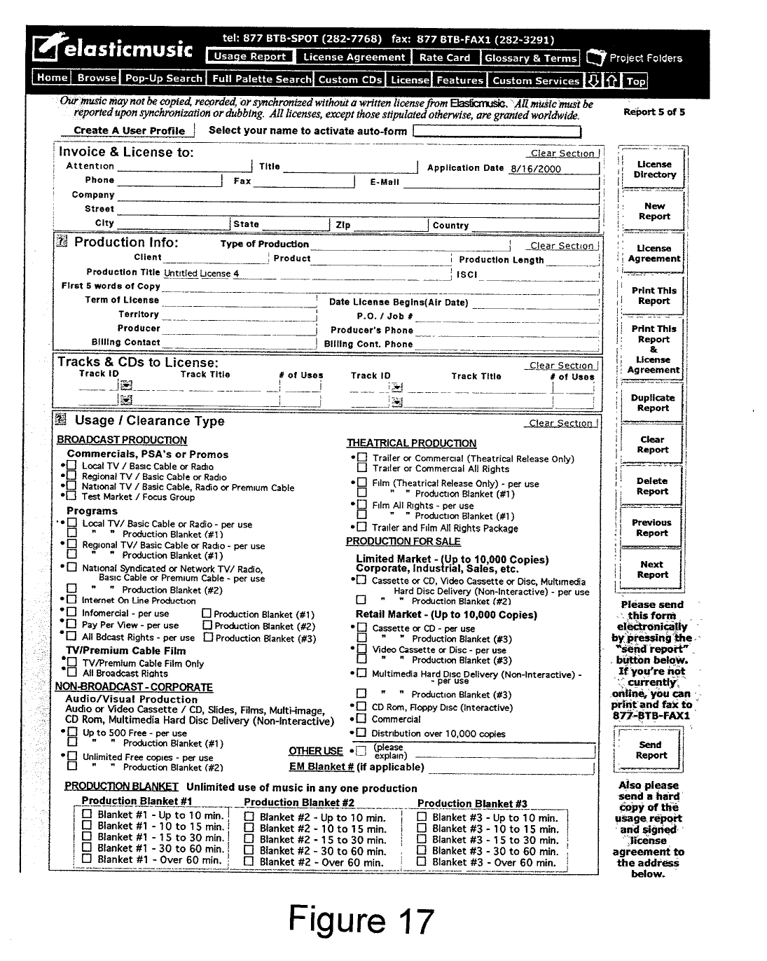

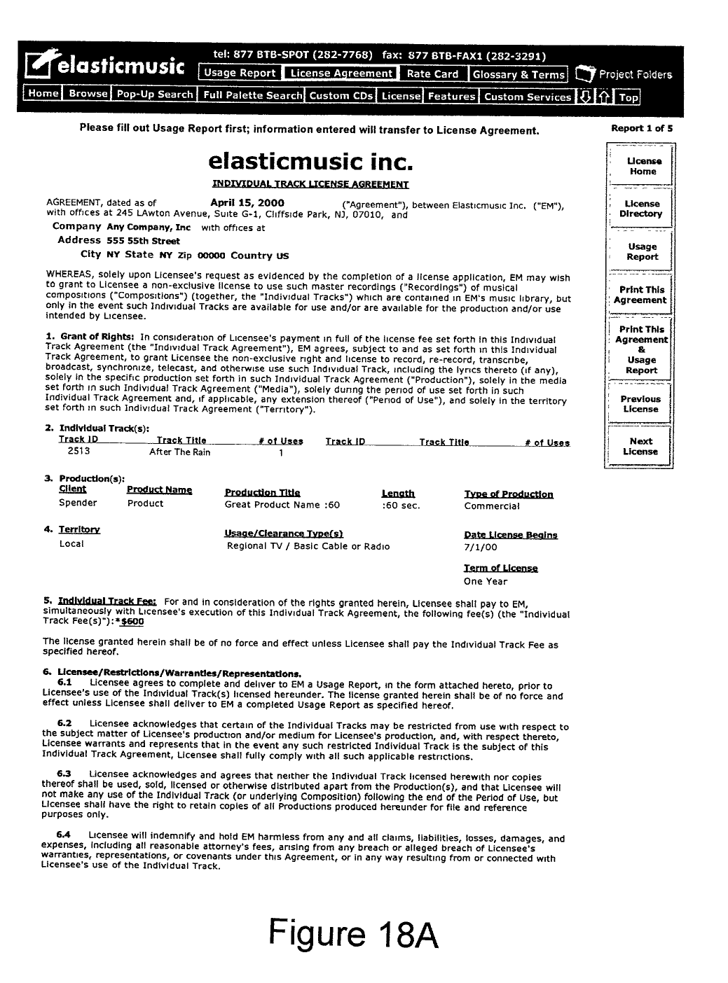

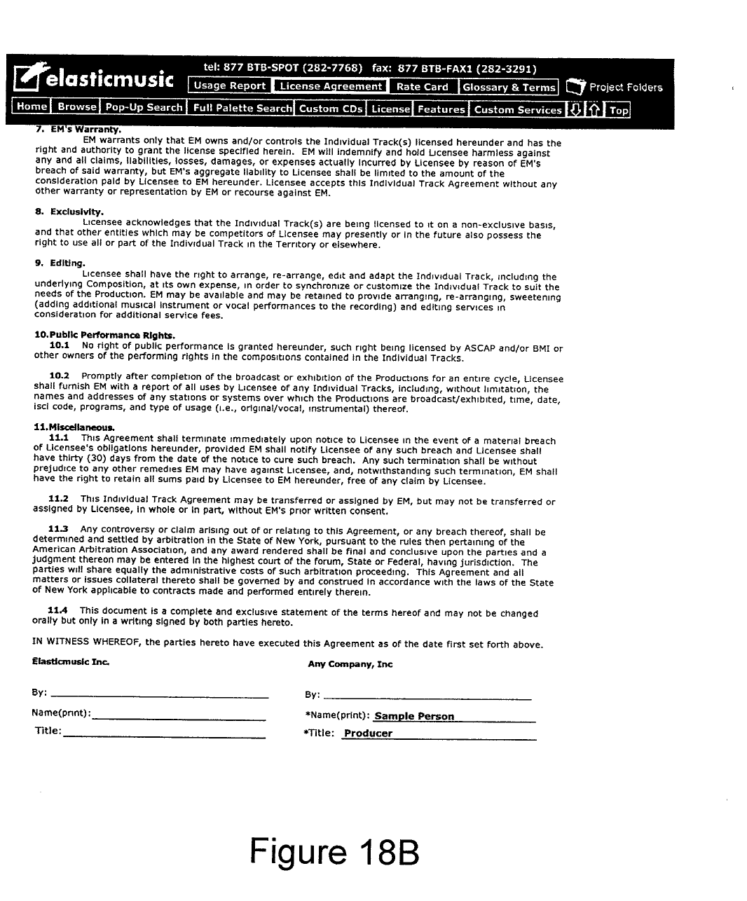

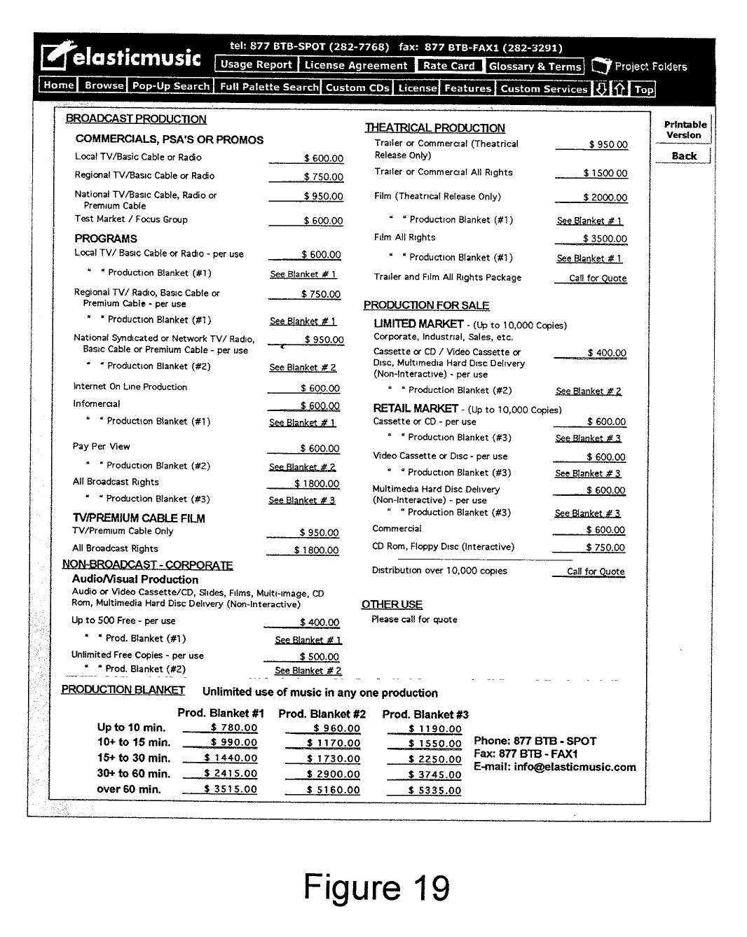

FIG. 16 is a graphical representation of screen display showing a web page for licensing a track. By activating a software button, the user can fill in a usage report as shown in FIG. 17. Also, one or more user profiles can be entered and recalled for quick pre-filling of information specific to that user. The user can also obtain a partially pre-filled license agreement to be completed either online or offline, as shown in FIGS. 18A and 18B. Furthermore, a usage rate card is available for user reference as shown in FIG. 19. Once the user's usage requirements are entered in the usage report, the license fee can be calculated specific to the usage data entered.

The above-described search functions are performed by search module 202 (FIG. 2) running on the server in conjunction with the system software, as well as in conjunction with application software running on the personal computer.

Process Flowchart

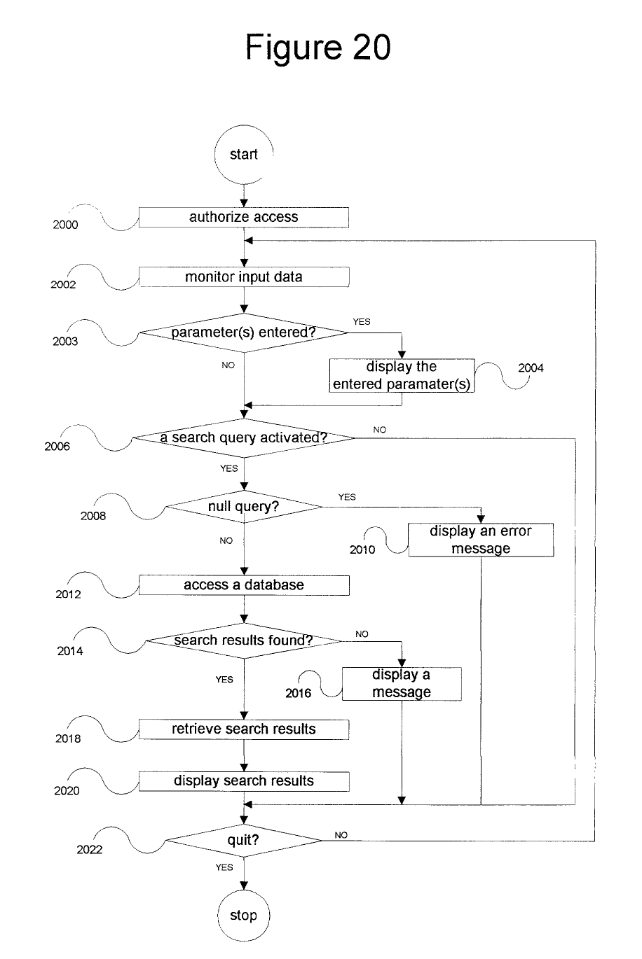

FIG. 20 is a process flowchart for searching for multimedia items in accordance with the present invention. In step 2000, the access to the web site is authorized for a registered user. The input data is then monitored in step 2002. It is then determined whether one or more parameters have been entered by the user in step 2003. The entered parameters are displayed on the screen in step 2004, and the process then continues with step 2006.

In step 2006, it is determined whether a search query has been activated. If no search query, the process continues with step 2022. Otherwise, another determination is made whether it is a null query in step 2008 If so, an error message is displayed on the screen in step 2010, and the process continues with step 2022.

If the query is not null, the database is accessed in step 2012. In step 2014, it is determined whether any search results have been found in the database. If no search results, a message is displayed to that effect in step 2016 and the process continues with step 2022.

In step 2018, the search results are retrieved from the database, and they are displayed on the screen in step 2020. In step 2022 it is determined whether the user wants to continue searching, go to other functions (such as project folders, CD/media orders, licensing, etc.), or quit this session and exit the program. If the user wants to continue searching, the process returns to step 2002 and the above-described operations are repeated. The user has ability to navigate from one function, window or module to any other at any time, offering non-linear random access between the search, search log, project folders, licensing, custom orders and all other modules.

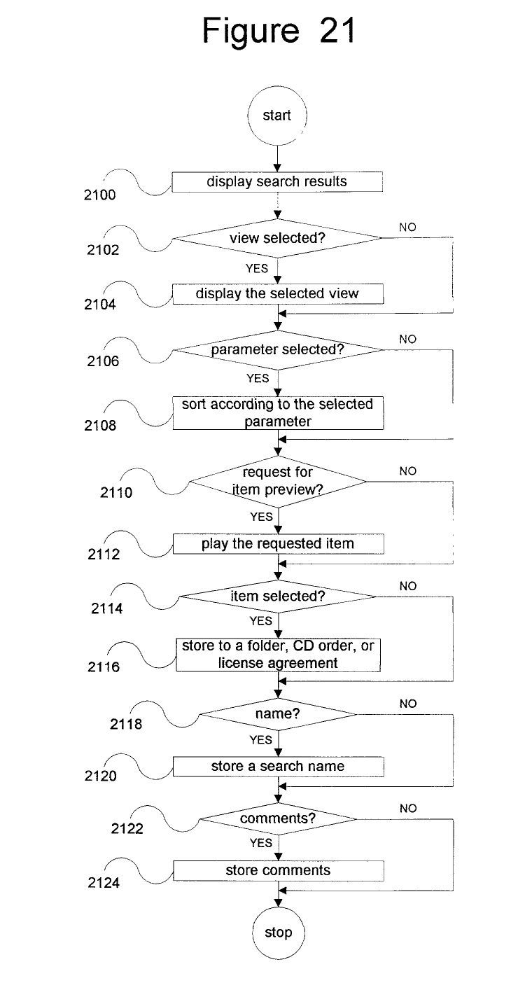

FIG. 21 is a process flowchart for displaying, sorting, and previewing the search results in accordance with the present invention. In step 2100, the search results are displayed. In step 2102, it is determined whether a particular view for displaying search results is selected by the user, and if so the selected view is displayed on the screen in step 2104.

In step 2106, it is determined whether a parameter is selected for sorting the search results, and if so, the search results are sorted according to the selected parameter(s) in step 2108.

In step 2110 of FIG. 21, it is determined whether the user requested a preview or compete listen/viewing of the item. If so, the requested item is played on screen in step 2112.

In step 2114, it is determined whether a multimedia item is selected. If so, the selected item is stored to a designated folder, sent to a CD/media order, license agreement or other storage module for a partial pre-fill of information in step 2116

In step 2118, it is determined whether the user provided a name for the search. If so, the search is stored under the user-provided name in step 2120.

In step 2122, it is determined whether any comments are entered with reference to the music, photo, video cut or other multimedia content. If so, the comments are stored in step 2124.

The above description of the process flowcharts and FIGS. 1-19 refers to various functions which can be executed with any sequence determined by the user. It is understood, of course, that those and other operations are performed by one or more programmable processors/controllers in the server and in the PCs executing appropriate program code stored on a computer-readable storage medium. As known to those skilled in the art, a programmable processor/controller retrieves the code, transfers the retrieved code to its internal memory and executes it from the internal memory. In response to the executed code, the appropriate actions take place to carry out the above-described and other functions of the system.

While the above arrangement is the preferred embodiment for the present invention, it is not limited thereto. In the present invention, dumb terminals may replace the personal computers, or alternatively personal computers may be utilized merely as dumb terminals. In this configuration, the terminals are connected via wires (without modems) to a main computer, where all processing operations take place such that the users use the terminals only as data input devices.

Yet in another arrangement, the present invention may be implemented on a microprocessor-accessible storage medium such as computer memory, hard drive, compact disk (CD), video cassette, digital video disk (DVD), Digital Audio Tape (DAT), etc. In this case, the entire program code and multimedia information is stored on the storage medium that can be accessed by a microprocessor, programmable controller, or any other programmable device

It will be appreciated that the present invention provides the flexibility of selecting from a single window different plug-ins to play or download the music. Namely, the user has one play button in the search return window, but the plug-in that is used when the user presses the play button is dependent on the setting that the user sets in another page or on the top of that window. Additionally, the user may select to play or download items not only in the search return, but also in any storage area such as, but not limited to, folders and orders.

It will be further appreciated that in accordance with the present invention there is a feature of including a notepad accessible from the home page. This may be a paper icon in the lower left comer of the home page, for example, whereby a user can store global notes pertaining to the software, his projects, general approach, tech support hints, etc.

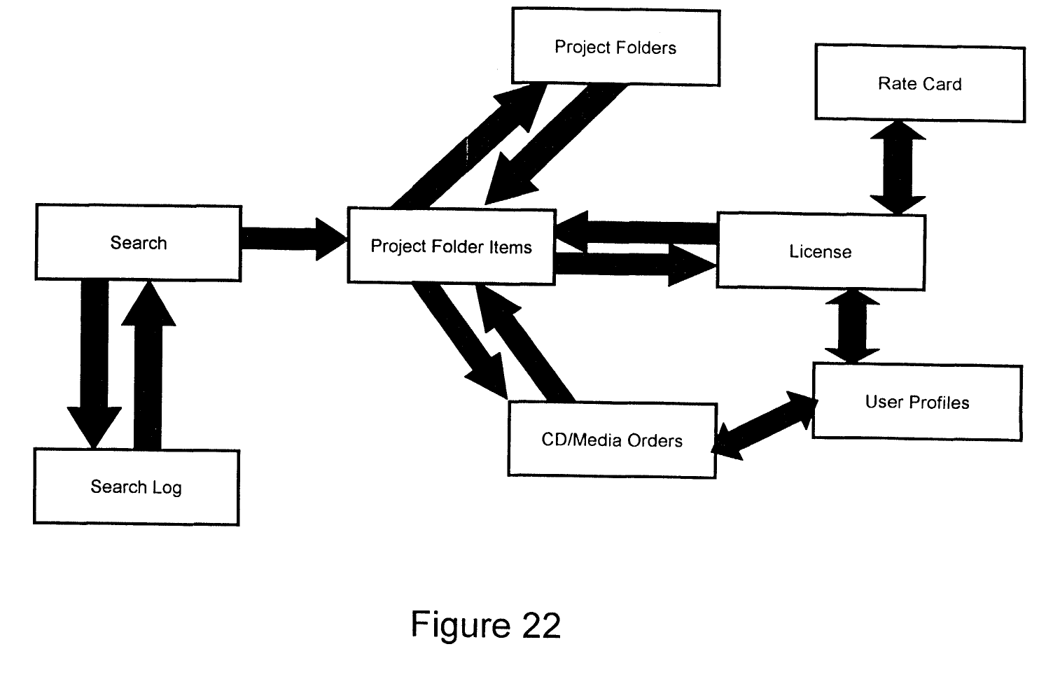

Filemaker Pro® is representatively used as the database platform in the current embodiment of the present invention. It is understood, of course, that other database platforms may be used as well. FIG. 22 is a block diagram illustrating the database structure in accordance with one representative embodiment of the present invention.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for searching multimedia content stored in a microprocessor-based storage medium, comprising:
receiving a user-entered parameter relating to a multimedia item; and
retrieving said multimedia item based on said user-entered parameter that represents a tempo of the retrieved multimedia item, said tempo being defined by a user-specified time period that a predetermined number of beats lasts for.

2. The method according to claim 1, wherein said user-entered parameter is defined in such a way that the retrieved multimedia item contains said user-specified time period exactly.

3. The method according to claim 1, wherein said user-entered parameter is defined in such a way that the retrieved multimedia item contains said user-specified time period within a predetermined range.

4. The method according to claim 1, wherein said user-entered parameter is defined in such a way that the retrieved multimedia item contains said user-specified time period within a predetermined percentage of error.

5. A method for searching multimedia content stored in a microprocessor-based storage medium, comprising:
receiving a user-entered parameter relating to a multimedia item;
retrieving said multimedia item based on the user-entered parameter; and
displaying information related to the retrieved multimedia item, whereby the displayed information includes a tempo as defined by a user-specified time period that a predetermined number of beats lasts for.

6. A method for searching multimedia content stored in a microprocessor-based storage medium, comprising
receiving a user-entered parameter relating to a multimedia item, and
retrieving said multimedia item based on the user-entered parameter that represents tempo of the retrieved multimedia item, said tempo being defined by a user-specified range of a number of beats per minute.

7. A method for searching multimedia content stored in a microprocessor-based storage medium, comprising:
receiving a user-entered parameter relating to a multimedia item; and
retrieving said multimedia item based on the user-entered parameter that represents tempo of the retrieved multimedia item, said tempo being defined by a user-specified number of beats per minute within a predetermined percentage of error.

8. A method for searching multimedia content stored in a microprocessor-based storage medium, comprising:
receiving a user-entered parameter relating to a multimedia item; and
retrieving said multimedia item based on the user-entered parameter that represents a keyword of the retrieved multimedia item, such that said keyword is one selected from a word, a number, and a symbol contained in a profile of the retrieved multimedia item, the user-entered parameter being specified in such a way that content is omitted from a retrieved multimedia item list.

9. A method for searching multimedia content stored in a microprocessor-based storage medium, comprising
receiving a user-entered parameter relating to a multimedia item; and
retrieving said multimedia item based on the user-entered parameter that represents a keyword of the retrieved multimedia item, said keyword being a synonym of a word contained in said profile.

10. The method according to claim 9, wherein if said synonym has alternate meanings, then the user is prompted to select a desired meaning.

11. A method for searching multimedia content stored in a microprocessor-based storage medium, comprising:
receiving a user-entered parameter relating to a multimedia item; and
retrieving said multimedia item based on said user-entered parameter relating to data representing vocal content.

12. The method according to claim 11, wherein the vocal content is one selected from vocals with lyrics, vocals without lyrics, and absence of vocals.

13. The method according to claim 11, wherein the vocal content is selected by the language of lyrics.

14. A method for searching multimedia content stored in a microprocessor-based storage medium, comprising:
receiving a user-selected parameter relating to a multimedia item,
retrieving said multimedia item based on the user-selected parameter, wherein parameters for user selection are displayed in a predetermined geometric figure.

15. The method according to claim 14, further comprising selecting a plurality of parameters from a category.

16. The method according to claim 14, wherein a plurality of parameters is selected for the same search, and wherein a plurality of geometric figures are used such that each figure represents a different parameter category.

17. The method according to claim 14, further comprising choosing, from a number of geometric figure categories, which of those geometric figure categories are to be displayed.

18. The method according to claim 14, wherein said geometric figure is a palette.

19. The method according to claim 14, wherein said geometric figure is one selected from a wheel, a square, a rectangle, an oval, a triangle, and a straight line.

20. The method according to claim 14, further comprising displaying similar parameters within a category adjacent to each other in said geometric figure.

21. A method for searching multimedia content stored in a microprocessor-based storage medium, comprising:
receiving a user-entered parameter relating to a multimedia item; and
retrieving said multimedia item based on the user-entered parameter, wherein parameters for user selection are selected from at least two search parameter displays, such that a parameter entered in a first search parameter display is retained when switching to a second search parameter display.

22. A method for searching multimedia content stored in a microprocessor-based storage medium, comprising:
receiving a user-entered parameter relating to a multimedia item;
retrieving first and second multimedia items based on the user-entered parameter; and
sorting said first and second multimedia items based on user-specified information.

23. The method according to claim 22, wherein said user-specified information is density of the item.

24. The method according to claim 22, wherein said user-specified information is the complementary quality of the item.

25. The method according to claim 22, wherein said user-specified information is relevance to specific parameters selected, such that multimedia items that match the user's query most closely are brought to a top of a search return list.

26. The method according to claim 22, wherein said user-specified information is status of whether an item is marked to be moved to a CD/media order, to be downloaded, to be moved to a license agreement, or to be moved to a storage module.

27. The method according to claim 22, wherein said user-specified information is user-entered comments related to particular items.

28. The method according to claim 22, wherein said user-specified information is a user-specified sort order.

29. A method for searching multimedia content stored in a microprocessor-based storage medium, comprising:
receiving a user-entered parameter relating to a multimedia item;
retrieving said multimedia item based on the user-entered parameter; and
deleting th e selected retrieved multimedia item from a display screen.

30. A method for searching multimedia content stored in a microprocessor-based storage medium, comprising
receiving a user-entered parameter relating to a multimedia item;
retrieving said multimedia item based on the user-entered parameter; and
displaying information related to the retrieved multimedia item, the displayed information being selected from at least2 views such that each view offers different amounts or types of information.

31. The method according to claim 30, further comprising selecting from said at least 2 views within a project folder, a CD/media order, a license form, or a storage module.

32. The method according to claim 30, further comprising viewing restrictions of use for multimedia items contained in a system.

33. The method according to claim 30, further comprising viewing restrictions of use specific to an individual multimedia item.

34. A system for searching multimedia content stored in a microprocessor-based storage medium, comprising:
means for receiving a user-entered parameter relating to a multimedia item; and
means for retrieving said multimedia item based on said user-entered parameter that represents a tempo of the retrieved multimedia item, said tempo being defined by a user-specified time period that a predetermined number of beats lasts for.

35. The system according to claim 34, wherein said user-entered parameter is defined in such a way that the retrieved multimedia item contains said user-specified time period exactly

36. The system according to claim 34, wherein said user-entered parameter is defined in such a way that the retrieved multimedia item contains said user-specified time period within a predetermined range.

37. The system according to claim 34, wherein said user-entered parameter is defined in such a way that the retrieved multimedia item contains said user-specified time period within a predetermined percentage of error.

38. A system for searching multimedia content stored in a microprocessor-based storage medium, comprising:
means for receiving a user-entered parameter relating to a multimedia item;
means for retrieving said multimedia item based on the user-entered parameter; and
means for displaying information related to the retrieved multimedia item, whereby the displayed information includes a tempo as defined by a user-specified time period that a predetermined number of beats lasts for.

39. A system for searching multimedia content stored in a microprocessor-based storage medium, comprising:
means for receiving a user-entered parameter relating to a multimedia item, and
means for retrieving said multimedia item based on the user-entered parameter that represents tempo of the retrieved multimedia item, said tempo being defined by a user-specified range of a number of beats per minute.

40. A system for searching multimedia content stored in a microprocessor-based storage medium, comprising:
means for receiving a user-entered parameter relating to a multimedia item; and
means for retrieving said multimedia item based on the user-entered parameter that represents tempo of the retrieved multimedia item, said tempo being defined by a user-specified number of beats per minute within a predetermined percentage of error.

41. A system for searching multimedia content stored in a microprocessor-based storage medium, comprising:
means for receiving a user-entered parameter relating to a multimedia item; and
means for retrieving said multimedia item based on the user-entered parameter that represents a keyword of the retrieved multimedia item, such that said keyword is one selected from a word, a number, and a symbol contained in a profile of the retrieved multimedia item, the user-entered parameter being specified in such a way that content is omitted from a retrieved multimedia item list.

42. A system for searching multimedia content stored in a microprocessor-based storage medium, comprising:
means for receiving a user-entered parameter relating to a multimedia item, and
means for retrieving said multimedia item based on the user-entered parameter that represents a keyword of the retrieved multimedia item, said keyword being a synonym of a word contained in said profile.

43. The system according to claim 42, wherein if said synonym has alternate meanings, then the user is prompted to select a desired meaning.

44. A system for searching multimedia content stored in a microprocessor-based storage medium, comprising:
means for receiving a user-entered parameter relating to a multimedia item; and
means for retrieving said multimedia item based on said user-entered parameter relating to data representing vocal content.

45. The system according to claim 44, wherein the vocal content is one selected from vocals with lyrics, vocals without lyrics, and absence of vocals.

46. The system according to claim 44, wherein the vocal content is selected by the language of lyrics.

47. A system for searching multimedia content stored in a microprocessor-based storage medium, comprising:
means for receiving a user-selected parameter relating to a multimedia item,
means for retrieving said multimedia item based on the user-selected parameter, wherein parameters for user selection are displayed in a predetermined geometric Figure

48. The system according to claim 47, further comprising means for selecting a plurality of parameters from a category.

49. The system according to claim 47, wherein a plurality of parameters is selected for the same search, and wherein a plurality of geometric figures are used such that each figure represents a different parameter category.

50. The system according to claim 47, further comprising means for choosing, from a number of geometric figure categories, which of those geometric figure categories are to be displayed.

51. The system according to claim 47, wherein said geometric figure is a palette.

52. The system according to claim 47, wherein said geometric figure is one selected from a wheel, a square, a rectangle, an oval, a triangle, and a straight line.

53. The system according to claim 47, further comprising means for displaying similar parameters within a category adjacent to each other in said geometric figure.

54. A system for searching multimedia content stored in a microprocessor-based storage medium, comprising:
means for receiving a user-entered parameter relating to a multimedia item; and
means for retrieving said multimedia item based on the user-entered parameter, wherein parameters for user selection are selected from at least two search parameter displays, such that a parameter entered in a first search parameter display is retained when switching to a second search parameter display.

55. A system for searching multimedia content stored in a microprocessor-based storage medium, comprising:
means for receiving a user-entered parameter relating to a multimedia item;
means for retrieving first and second multimedia items based on the user-entered parameter; and
means for sorting said first and second multimedia items based on user-specified information.

56. The system according to claim 55, wherein said user-specified information is density of the item.

57. The system according to claim 55, wherein said user-specified information is the complementary quality of the item.

58. The system according to claim 55, wherein said user-specified information is relevance to specific parameters selected, such that multimedia items that match the user's query most closely are brought to a top of a search return list.

59. The system according to claim 55, wherein said user-specified information is status of whether an item is marked to be moved to a CD/media order, to be downloaded, to be moved to a license agreement, or to be moved to a storage module.

60. The system according to claim 55, wherein said user-specified information is user-entered comments related to particular items.

61. The system according to claim 55, wherein said user-specified information is a user-specified sort order.

62. A system for searching multimedia content stored in a microprocessor-based storage medium, comprising:
means for receiving a user-entered parameter relating to a multimedia item;
means for retrieving said multimedia item based on the user-entered parameter; and
means for deleting the selected retrieved multimedia item from a display screen.

63. A system for searching multimedia content stored in a microprocessor-based storage medium, comprising:
means for receiving a user-entered parameter relating to a multimedia item;
means for retrieving said multimedia item based on the user-entered parameter; and
means for displaying information related to the retrieved multimedia item, the displayed information being selected from at least 2 views such that each view offers different amounts or types of information.

64. The system according to claim 63, further comprising means for selecting from said at least 2 views within a project folder, a CD/media order, a license form, or a storage module.

65. The system according to claim 63, further comprising means for viewing restrictions of use for multimedia items contained in a system.

66. The system according to claim 63, further comprising means for viewing restrictions of use specific to an individual multimedia item

67. A computer-readable storage medium having recorded thereon code, executable by a programmable controller, for searching multimedia content, said storage medium comprising:
first code means for receiving a user-entered parameter relating to a multimedia item; and
second code means for retrieving said multimedia item based on said user-entered parameter that represents a tempo of the retrieved multimedia item, said tempo being defined by a user-specified time period that a predetermined number of beats lasts for.

68. The storage medium according to claim 67, wherein said user-entered parameter is defined in such a way that the retrieved multimedia item contains said user-specified time period exactly.

69. The storage medium according to claim 67, wherein said user-entered parameter is defined in such a way that the retrieved multimedia item contains said user-specified time period within a predetermined range.

70. The storage medium according to claim 67, wherein said user-entered parameter is defined in such a way that the retrieved multimedia item contains said user-specified time period within a predetermined percentage of error.

71. A computer-readable storage medium having recorded thereon code, executable by a programmable controller, for searching multimedia content, said storage medium comprising:
first code means for receiving a user-entered parameter relating to a multimedia item;
second code means for retrieving said multimedia item based on the user-entered parameter; and
third code means for displaying information related to the retrieved multimedia item, whereby the displayed information includes a tempo as defined by a user-specified time period that a predetermined number of beats lasts for.

72. A computer-readable storage medium having recorded thereon code, executable by a programmable controller, for searching multimedia content, said storage medium comprising:
first code means for receiving a user-entered parameter relating to a multimedia item; and
second code means for retrieving said multimedia item based on the user-entered parameter that represents tempo of the retrieved multimedia item, said tempo being defined by a user-specified range of a number of beats per minute.

73. A computer-readable storage medium having recorded thereon code, executable by a programmable controller, for searching multimedia content, said storage medium comprising
first code means for receiving a user-entered parameter relating to a multimedia item; and
second code means for retrieving said multimedia item based on the user-entered parameter that represents tempo of the retrieved multimedia item, said tempo being defined by a user-specified number of beats per minute within a predetermined percentage of error.

74. A computer-readable storage medium having recorded thereon code, executable by a programmable controller, for searching multimedia content, said storage medium comprising:
first code means for receiving a user-entered parameter relating to a multimedia item; and
second code means for retrieving said multimedia item based on the user-entered parameter that represents a keyword of the retrieved multimedia item, such that said keyword is one selected from a word, a number, and a symbol contained in a profile of the retrieved multimedia item, the user-entered parameter being specified in such a way that content is omitted from a retrieved multimedia item list.

75. A computer-readable storage medium having recorded thereon code, executable by a programmable controller, for searching multimedia content, said storage medium comprising:
first code means for receiving a user-entered parameter relating to a multimedia item; and
second code means for retrieving said multimedia item based on the user-entered parameter that represents a keyword of the retrieved multimedia item, said keyword being a synonym of a word contained in said profile.

76. The storage medium according to claim 75, wherein if said synonym has alternate meanings, then the user is prompted to select a desired meaning.

77. A computer-readable storage medium having recorded thereon code, executable by a programmable controller, for searching multimedia content, said storage medium comprising:
first code means for receiving a user-entered parameter relating to a multimedia item, and
second code means for retrieving said multimedia item based on said user-entered parameter relating to data representing vocal content.

78. The storage medium according to claim 77, wherein the vocal content is one selected from vocals with lyrics, vocals without lyrics, and absence of vocals.

79. The storage medium according to claim 77, wherein the vocal content is selected by the language of lyrics.

80. A computer-readable storage medium having recorded thereon code, executable by a programmable controller, for searching multimedia content, said storage medium comprising:
first code means for receiving a user-selected parameter relating to a multimedia item;
second code means for retrieving said multimedia item based on the user-selected parameter, wherein parameters for user selection are displayed in a predetermined geometric figure.

81. The storage medium according to claim 80, further comprising third code means for selecting a plurality of parameters from a category.

82. The storage medium according to claim 80, wherein a plurality of parameters is selected for the same search, and wherein a plurality of geometric figures are used such that each figure represents a different parameter category.

83. The storage medium according to claim 80, further comprising third code means for choosing, from a number of geometric figure categories, which of those geometric figure categories are to be displayed

84. The storage medium according to claim 80, wherein said geometric figure is a palette.

85. The storage medium according to claim 80, wherein said geometric figure is one selected from a wheel, a square, a rectangle, an oval, a triangle, and a straight line.

86. The storage medium according to claim 80, further comprising third code means for displaying similar parameters within a category adjacent to each other in said geometric figure.

87. A computer-readable storage medium having recorded thereon code, executable by a programmable controller, for searching multimedia content, said storage medium comprising:
first code means for receiving a user-entered parameter relating to a multimedia item; and
second code means for retrieving said multimedia item based on the user-entered parameter, wherein parameters for user selection are selected from at least two search parameter displays, such that a parameter entered in a first search parameter display is retained when switching to a second search parameter display.

88. A computer-readable storage medium having recorded thereon code, executable by a programmable controller, for searching multimedia content, said storage medium comprising:
first code means for receiving a user-entered parameter relating to a multimedia item;
second code means for retrieving first and second multimedia items based on the user-entered parameter and
third code means for sorting said first and second multimedia items based on user-specified information.

89. The storage medium accordig to claim 88, wherein said user-specified information is density of the item.

90. The storage medium according to claim 88, wherein said user-specified information is the complementary quality of the item.

91. The storage medium according to claim 88, wherein said user-specified information is relevance to specific parameters selected, such that multimedia items that match the user's query most closely are brought to a top of a search return list.

92. The storage medium according to claim 88, wherein said user-specified information is status of whether an item is marked to be moved to a CD/media order, to be downloaded, to be moved to a license agreement, or to be moved to a storage module.

93. The storage medium according to claim 88, wherein said user-specified information is user-entered comments related to particular items.

94. The storage medium according to claim 88, wherein said user-specified information is a user-specified sort order

95. A computer-readable storage medium having recorded thereon code, executable by a programmable controller, for searching multimedia content, said storage medium comprising:
first code means for receiving a user-entered parameter relating to a multimedia item;
second code means for retrieving said multimedia item based on the user-entered parameter; and
third code means for deleting the selected retrieved multimedia item from a display screen.

96. A computer-readable storage medium having recorded thereon code, executable by a programmable controller, for searching multimedia content, said storage medium comprising:
first code means for receiving a user-entered parameter relating to a multimedia item;
second code means for retrieving said multimedia item based on the user-entered parameter; and
third code means for displaying information related to the retrieved multimedia item, the displayed information being selected from at least 2 views such that each view offers different amounts or types of information.

97. The storage medium according to claim 96, further comprising fourth code means for selecting from said at least 2 views within a project folder, a CD/media order, a license form, or a storage module.

98. The storage medium according to claim 96, further comprising fourth code means for viewing restrictions of use for multimedia items contained in a system.

99. The storage medium according to claim 96, further comprising fourth code means for viewing restrictions of use specific to an individual multimedia item.
